(19) United States
(12) Patent Application Publication
(10) Pub. No.: US 2004/0143477 A1
(43) Pub. Date: Jul. 22, 2004

(54) Apparatus and methods for assisting with development management and/or deployment of products and services

(76) Inventor: Maryann Walsh Wolff, Sparks, NV (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/616,371

(22) Filed: Jul. 8, 2003

Related U.S. Application Data
(60) Provisional application No. 60/394,314, filed on Jul. 8, 2002.

(51) Int. Cl. G06F 17/60

(52) U.S. Cl. 705/9

(57) ABSTRACT

A method and system for managing a project. A set of templates is provided, each template corresponding to one or more tasks of the project to be performed. Steps of the project are performed in accordance with the templates, which may be selected from a set of default terfiplates, and may represent substantially all of the project. The project may be a good to be sold commercially, an information technology project to be implemented, or another type of project.

### CROSS REFERENCE TO RELATED APPLICATIONS

This application claims priority under 35 U.S.C. § 119(e) to U.S. Provisional Application No. 60/394,314 entitled “Automated Adaptive Method and System for Product Design and Management,” filed Jul. 8, 2002.

### FIELD OF THE INVENTION

The invention pertains to methods and apparatus for managing the development and deployment of products or services and, more particularly, to methods and apparatus for more organized and coordinated development and deployment of products and services.

### DISCUSSION OF RELATED ART

Business organizations often proceed in the development of goods or services in a haphazard manner. (“Products” in this specification refers to goods and services rendered to serve a business purpose such as development of goods to sell for a profit. “Project” refers to a specific instance of entering a product management initiative, whether to develop a new product or service, or to revise an earlier version of a product or service. A “product” may refer to a project to deliver products or services internally within an organization; for example, an Information Technologies department may initiate a project to deploy a commercial product within the organization, adding the departments' support services to adapt, deliver, and maintain the product as appropriate to that organization. “Development” includes development of both new products and modifications of existing products. “Product management” refers to managing all applicable phases of designing, creating, delivering, and supporting a particular product. This may include all functions involved with the product, including but not limited to finance, manufacturing, research and development, testing, training, marketing, sales, customer support, professional services, executive staffs, project management, legal services, distribution partners, customers, although using each and every one of these is not necessary for any particular product management system.)

For example, the product is designed with a general sense of its purposes and a general idea of how it will be manufactured, but there is no coordinated or formalized way of managing this process. The next product may be designed using some general ideas learned from design of the preceding one, but once again without a formal mechanism for passing on lessons learned.

Other business organizations use a highly structured, but static, project plan for the development and management of products. For example, the organization may set up a series of mile stones and deliverables.

For both, the process uses very little feedback during the product management cycle and coordination among team members is difficult.

To address this issue, some organizations have tried to coordinate the product management effort using shared documents on a computer system. Users can check-in and check-out documents as a way of coordinating the design, development, and management processes. Little may be done, however, to formalize how the documents are used, to assure that the appropriate steps are followed or to guarantee that all of the appropriate information points are passed forward or backward.

Another approach has been to employ project planners or schedule builders. These software tools all organize entry and tracking of tasks and deadlines. They may not, however, assist in the efficient completion (or intelligent completion) of any of these tasks. They tend to be set up in advance of the project and are only changed manually at the initiation of one of the people participating in the product process.

### SUMMARY OF THE INVENTIONS

According to one embodiment of the present invention, a method of managing a project is disclosed. According to this embodiment, a set of templates is provided. Each template corresponds to one or more tasks of the project to be performed (“task” refers to any module, activity or sub-activity, or group of these, which may be performed in executing a project). The steps of the project are performed in accordance with the templates. The templates may be selected from a set of default templates. Templates may represent substantially all of the project. The project may be a good to be sold commercially, an information technology project to be implemented, or another type of project.

According to another embodiment of the present invention, the templates may be pre-populated with information designed in advance, or acquired in connection with the performance of other projects.

According to another embodiment of the present invention, confidence factors may be specified for the tasks of the project. An aggregation of confidence factors among tasks may be determined, identifying a confidence factor for a larger segment of the project.

According to another embodiment of the present invention, a method of implementing a project is disclosed. According to this embodiment, a set of electronic templates is generated, each template corresponding to a respective task. According to this embodiment, respective templates are retrieved in conjunction with performance of the respective tasks. The templates are used to manage the project.

According to another embodiment, default templates are provided and modified to customize them for the project. Information from previous projects may be retrieved and used to determine the modifications to the default templates.

According to another embodiment of the present invention, proof points are provided for individual tasks within the project.

According to another embodiment of the present invention, templates are automatically updated based on changes to predecessor and/or successor tasks.

According to another embodiment of the present invention, success factors are identified for each of a plurality of tasks for the project. The success factors are evaluated as a component of completion of the task and may be calculated automatically.

According to another embodiment of the present invention, feedback is electronically recorded for use in future projects. According to another embodiment of the present invention, reference material is linked to tasks that may need to use it. According to another embodiment of the present invention, feedback information is linked to the templates used in conjunction with performing a project.

According to another embodiment of the present invention, automated alert criteria are specified for each of a plurality of tasks for the project.

The inventive concepts described above and in the detailed description may be implemented separately or in various combinations. In addition, each may be implemented in software, a computer, through specialized hardware or any combination of these. Certain aspects of the present invention may be provided on a computer-readable media for sale or distribution to others.

### BRIEF DESCRIPTION OF THE DRAWINGS

FIG. 1 illustrates one embodiment of a set of modules for project management according to one embodiment of the present inventions.

FIG. 2 illustrates one embodiment of the fields of a template, represented graphically.

FIG. 3 illustrates one embodiment of a method for multi-pass processing of a project activity.

FIG. 4 illustrates one embodiment of a method for completing a project using particular modules.

FIG. 5 illustrates one embodiment of a method for initializing a project.

FIG. 6 illustrates one embodiment of a method for initializing feedback in a project management system.

FIG. 7 illustrates one embodiment of a method for success criteria processing.

FIG. 8 illustrates one embodiment of an automated method for managing trade-offs in one embodiment of a priorities module.

FIG. 9 illustrates one embodiment of a user interface for accessing a project management tool.

FIG. 10 illustrates one embodiment of a user interface for an activity content builder.

FIGS. 11A-11E illustrate an example of a product management process performed according to one embodiment of the present inventions.

### DETAILED DESCRIPTION

Superior results and greater effectiveness can be achieved in product management with more structure and assistance. Doing so can assist the product management process by increasing the chance that important information will be considered at the right points of the design, development, deployment, and other product management processes.

Consequently, certain embodiments of the present invention structure the product management process into a set of primary modules each corresponding to a segment of the overall process. “Modules” is not intended to imply a particular implementation of the process as in a separate software module. Rather, “module” refers to the (potentially overlapping) classification of project activities into groups.

For certain classes of products, these modules can be common to all. Indeed, in certain embodiments, the use of common modules allows product meta-knowledge (i.e., knowledge about the particular products' design, development, or management) to be employed, helping to guide the focus of the various product management processes. For these embodiments, one can increase the chance that every important aspect of product management is considered and, when it is considered, that the appropriate inputs are available. While the modules described below are inventive, however, all aspects of the inventions described in this specification are not limited to use of these particular modules.

Modules for Product Development, According to Certain Embodiments.

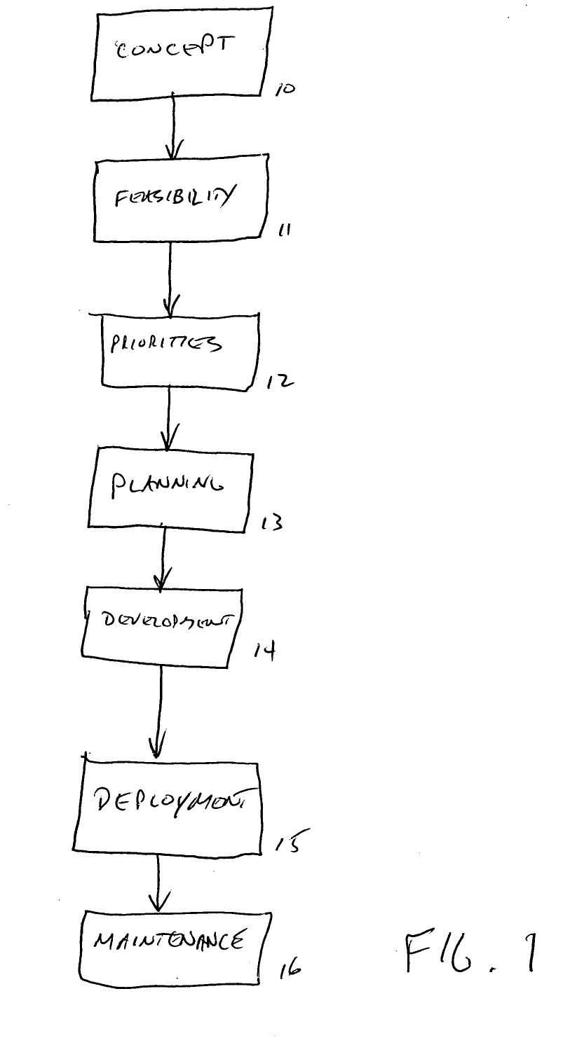

FIG. 1 illustrates one embodiment of the modules of product management that may be employed in a project. As described in greater detail below, software may be employed to assist the management process. This software may, in certain embodiments, be implemented using group-ware, i.e., allowing coordinated access by the multiple members of a project team. In other embodiments, a computer may not be employed. In these embodiments, the design process is structured more formally to include each of these modules.

At module 10, the project concept is formalized. For example, the product may be defined. The definition of the product may include a preliminary list of features, which may be refined in future steps. Nevertheless, the Concept Module includes at least a general outline of the product to be developed.

The Concept Module may further include market analysis. This includes identifying, gathering and organizing available data about the market for the product. Separately, or as a part of the market analysis, strategic and tactical fit information may be included. For example, certain products are necessary to offer in order to complete a product line—whether or not a substantial number of sales for that particular product are expected. Accordingly, strategic/tactical information concerning the concept of the product may be formalized as well.

At module 11 of FIG. 1, a feasibility study for the project is performed. The Feasibility Module addresses underlying business parameters for the product concept identified in the previous module. As for each of the other modules, there may be a number of sub-activities performed.

(The terms “activity” and “sub-activity” are used interchangeably in this specification; both refer to an activity performed in the product management project and each may be represented and/or implemented using a template as described below. Modules may have “activities” which then have “sub-activities,” although all can also be referred to generically as “sub-activities.” Any number of layers of “sub-activities” may be permitted or, in certain embodiments or for certain classes of design processes, the number of layers may be limited to avoid undue complexity for a particular project size; for example, a design process might be limited to three levels of module/activity/sub-activity, if further layering is not anticipated to be helpful.)

For the Feasibility Module, some of the sub-activities may include: formulation of a business plan to identify revenue, profit and cash flow issues for the product, if applicable; construction of a crude prototype or other demonstration that a critical component of the product can feasibly be performed (that prototype may be refined or reconstructed in future steps as well); preliminary identification of factors to determine the success of the product (e.g., using market analysis and strategic and tactical placement information determined in module 10); and definition of intellectual property that may either block production of the product (or certain features of the product) and preliminary identification of intellectual property that may be available to protect the product. When identifying available intellectual property protection in a preliminary phase, the market analysis and business plan may be used to assess the need for intellectual property protection in order to protect the market to have a successful product; where entry barriers are very low, intellectual property protection may be very important for a successful product.

In module 12 of FIG. 1, the priorities of the project are identified. The Priorities Module includes an assessment of the importance of various aspects of the project, such as the various features of the product as well as the relative importance of aspects of the development process such as time to market, cost and price. As for the other modules, each may use information determined from the previous modules.

Sub-activities for the Priorities Module may include collecting information helpful to make trade-off decisions both in this module and at later times. To assist team members in setting priorities and assuring that trade-offs are made in the design process, the module again includes identification and refinement (or the opportunity for refinement) of product requirements, including product features, configuration/packaging options and related goods or services. An additional sub-activity for the priority phase may include development of a preliminary master schedule. This master schedule would include major milestones only and is a part of the formulation of a more detailed schedule in subsequent phases.

A product “feature” refers to product or services capabilities offered to a customer. A tangible product may have, for example, many features such as size, color, remote controls, etc. A product “feature” may include other service related aspects, such as the warranty period, training courses, 24 hour hot-line, etc. Each is considered a product “feature” because each relates to the overall success of the product.

The other sub-activities include the priorities and relative importance of the time to get the product to market, the cost and price points for the products, the tolerable risks associated with the product (including risks associated with various product features and risks associated with producing a product sooner but which includes more flaws). By automatically performing, or formally requiring the execution of, trade-offs among priorities, the project manager and team members can assure that intelligent trade-offs are made up-front (in the Priorities Module) and throughout the project. Indeed, a separate software tool may be incorporated into a system to evaluate success criteria; other mechanisms may also be implemented to permit (or require) iterative rounds of success criteria evaluation.

At the Planning Module 13 of FIG. 1, the first run at laying out the remainder of the project is performed. Once again, a number of sub-activities may be performed as a part of the planning exercise.

For example, a Master Schedule can be developed. A Master Schedule can include not only a project time line with mile stones, but can also track assumptions made for the product development, target release features and services and include contingency options for situations that do not occur as planned.

Another sub-activity of the planning module 13 may include the formation of a functional specification for the product. The functional specification may include usage scenarios and usability assessment based on the feature set selection.

A further sub-activity of the Planning Module may include more detailed statement of how the product is positioned in the competitive landscape or otherwise. This again interfaces both with the results of previous modules as well as with the selection of the functional specification and features of the product.

Another sub-activity can be a “micro-level” breakdown of the design process, by features or clusters of features. For example, a software product's design might include flow charts and the development process would include the actual programming or coding of the product. Here, the micro-level breakdown may include defining a set of flow charts and or code segments that would be needed to develop the product.

During the Planning Module, detailed design documents and a working prototype may also be developed.

Also an operations plan may be put in place as well as a market sales and distribution plan for fulfillment of the product.

A further sub-activity of the planning module can include legal planning. For example, contracts for the provision of goods or services can be developed (and certainly the model for these can be formed). In addition, a plan can be put in place for pursuit of any intellectual property protecting the product.

As for the other modules, additional sub-activities may be included and every project need include each of these sub-activities.

At module 14 of FIG. 1, the development of the product is pursued. The development module executes each of the portions that were planned in the Planning Module. Part of the Development Module may include the completion not just of product design but also the placement of everything required for manufacture/purchase/contracting for delivery and deployment of the product, with all its features. The development cycle may include sub-activities related to the development of contingencies while development is on-going. For example, contingency features or upgrades may be developed in parallel with product development. Contingency features and downgrades may further be planned. In addition, contingency product release points may be planned for, in the event that the schedule proceeds more or less quickly than originally planned.

Further sub-activities that are included in the Development Module in this embodiment include completion of marketing materials, completion of delivery vehicles, and sub-activities directed to testing. For the latter, different sub-activities may be related to testing units, testing integration and testing features and procedures related to deployment of the product. A further sub-activity directed to surrounding services may also be included. This sub-activity may be directed to components for training, documentation, installation and support, and may include automated software utilities or other input mechanisms to pre-populate deliverable documents such as a pre-installation check list, a user guide, or other deliverable without having to completely write the deliverable document from scratch.

At module 15 of FIG. 1, the product is deployed. This may include sub-activities directed to deployment to customers (for some products) including phased deployment from pilot through commercial release, deployment among partners, and public relations. Further sub-activities may include monitoring product acceptance and feedback and measuring that feedback against the success criteria established earlier. In addition, success criteria can be measured from other sources, such as time to market, cost of product, etc.

In module 16 of FIG. 1, product maintenance is performed. Product maintenance refers generally to on-going monitoring of feedback pertaining to the product. As described below, this feedback may be used not only to improve the product, but also for learning with respect to the product management in this cycle as it may be applied to projects in the future.

The sub-activities that may be performed in the Maintenance Module may include a number of “loops” that are continually performed and where some feedback is sought, received and analyzed. These loops may include, for example, information loops for the organization/operations (including feedback based on manufacturing, distribution, etc.); customer information loops directed to seeking, receiving and analyzing feedback from customers; partner information loops, directed to feedback from business partners in connection with fulfillment of the product; marketing (PR and advertising) and industry information loops, seeking information about the market and the industry and including monitoring the activity of competitors with respect to intellectual property in the product or intellectual property held by the competitors; intellectual property maintenance loops, where the on-going pursuit of intellectual property is monitored; and product continuance evaluation, where the continued viability of the present product in its present form is examined periodically.

The foregoing describes one example of modularized product management. By applying a formal mechanism to structure product management, one can assure that the various modules and sub-activities are performed (or specifically considered and determined to be inapplicable). The modules can be organized differently without departing from the scope of the inventions described in this specification.

Use of Templates to Assist Completion, Coordination and Tracking of Modules and Sub-Activities.

According to certain embodiments of the present inventions, templates (electronic or physical) may be used to assist in assuring that the appropriate parameters are considered during the product management process and to coordinate completion of tasks (particularly where the templates are accessible electronically). “Templates” refers to any structured format for organizing data, without regard to the particular format used. If the templates are implemented in software on a computer, inputs and results from each module or sub-activity may automatically propagate to other templates.

Templates may be generated generically for product management and/or tailored to specific projects starting from one of a set of possible templates. One aspect of the present inventions includes the formation of template sets for different categories of products and services, based on past experience. Such templates can themselves be valuable guides to the product development process. For example, one set of templates could be used for a simple mechanical consumer product, a different set for a computer product, and yet another set for the internal deployment of financial and accounting software within a multi-national organization. In addition, as templates are tailored for new products, those templates may be archived for use in similar products in the future.

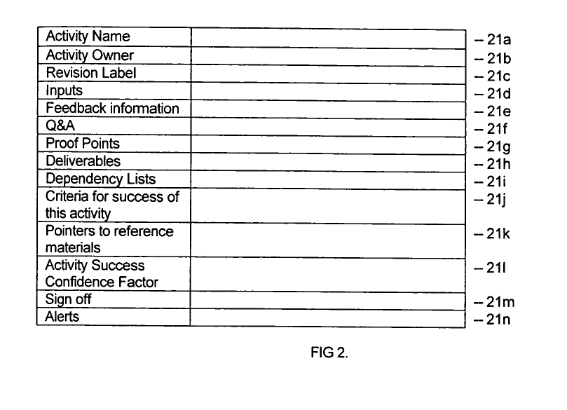

FIG. 2 illustrates one generic template that can be used as a starting place to form specific templates for each module and/or sub-activity (sub-activities may have further sub-activities within them). As can be seen from the figure, a number of fields can be common for each module/sub-activity within a specific project.

In the example of FIG. 2, each row represents a field of value or values that can be entered as a part of a specific project activity. Some fields, such as Question and Answer (Q&A) fields may include a structured format for inputting data into the template.

The first field 21a in FIG. 2 includes the activity name for the template. For example, there may be a template for the Priorities Module 12 of FIG. 1. That template may have an activity name of “Priorities Module.”

The template may also include a field 21b for identifying the activity owner. While many members of a project team may work on a project, it is important in many contexts for an individual to be responsible for a module or activity. The identity of this person could be specified in field 21b. In other fields (not shown), other team members could also be identified as well as an explanation of their roles.

In field 21c, the revision label could be specified. The revision label is a field used to track the revision/version for the template. Thus, when templates are updated, a historical or archival copy could be retained. Statistical comparison may also be made at this point as a cross-check.

In field 21d, the inputs for the particular template are identified. These may include links that specify the other module or activity results which are input for use in the activity performed using the template of FIG. 2. When implemented in software, for example, the inputs from other tasks may be updated automatically in the applicable template.

In field 21e, feedback information is identified. Feedback information refers to inputs for the particular template that result from feedback from analysis performed as part of another activity (e.g., customer evaluation or beta testing), or feedback information obtained in analogous design projects, as described in greater detail below.

Field 21f includes questions and answers that can guide or structure the completion of the module or task that is represented by the template. The process of completing these questions and answers may substantially involve completion of the activity represented by the template. In software, question and answer wizards may be used to assist in assuring that each of the questions are addressed. As one example, for a priority module, one of the questions may require the user to identify each of the features in the order of their importance or with an associated weight to represent the importance of the feature. Another question may ask for the operator to identify the importance of time to market. Some questions may require the completion of a sub-activity. For example, a question might require the development of a full design specification. Completing the answer to this question may invoke a sub-activity template for the design, which itself may have sub-activity templates corresponding to graphic design, design of subcomponents, etc.

The field 21g for proof points includes a specification of what data needs to be gathered to assure that the activity represented by the template in FIG. 2 is performed adequately. For example, proof points associated with prioritization of product features may involve the gathering and assessment of identified types market data; proof points associated with manufacturing costs may require obtaining at least one bid from a manufacturer.

The field 21h specifies the deliverables for the template. This is the end result (such as a detailed design document) for this particular activity.

Field 21i specifies dependency lists. This list includes all of the other templates or activities that will receive input as a result of completion of this activity and the predecessor activities that created content for use in this activity.

Field 21j includes a set of criteria for success of this activity. These may include unstructured input (such as securing approval of a supervisor) or measurable quantities to help determine whether this activity has been performed successfully. Some measures of success may be assessed at the time that the activity is performed, such as verification of the cost of manufacture for a product. Other measures of success may require feedback in the future (for example, after the product has been launched), to determine whether this aspect of the project was successful. Use of information gathered in the future is particularly helpful when the results of the project are used in future product efforts.

Field 21k includes pointers to reference materials, for example, a particular project activity may require, or be assisted with, access to various manufacturing sources. This field could then provide ready access to materials related to manufacturing sources.

Field 21l permits the activity owner to specify the confidence that this particular activity will be completed successfully. That confidence level can be adjusted as the activity is being completed. For example, the initial confidence level may only be 6 out of 10. As progress develops, however, the activity owner may raise the rating of confidence that the activity will result in successful completion.

Field 21m may include an area for a sign off. Here, a user may specify the identity of a person or group that has to sign off that an activity has been completed, and an indication of whether that person has signed off.

Last in this example, in field 21n, certain alerts can be identified. Here, an alert can be automatically issued in the event that the activity is being performed in a manner that puts the project at risk. For example, an alert might be issued if the activity has not been completed by a certain deadline or if the confidence level of success has not been raised to a certain level by a certain time period. Similarly, if the manufacturing costs being assessed at an activity level are too high, an alert can be issued. This permits others on the project team to know immediately when there is a significant risk factor in the product development process, at the time that the risk is first identified.

The use of templates may be better understood through the use of an example. Before this is done, however, another aspect of certain embodiments of the present inventions is described—iterative feedback in completion of tasks (such as modules or activities) during the product development cycle. Traditionally, tasks are performed once in a product design “cycle” (in this regard, the word “cycle” is a misnomer).

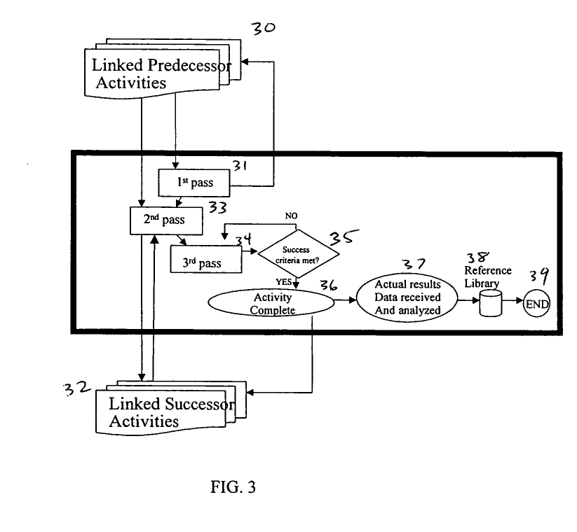

This principle can be illustrated with reference to FIG. 3. At step 30, information from linked predecessor activities is received. When implemented in software, this can be done automatically. Generally, this corresponds to a subset of the total input information received as specified in field 21d of FIG. 2.

Initially, this information is fed into an activity template, as described above. The activity is then performed in a first pass, at step 31. The activity is completed as will be done for the ordinary design process, where using a template as described above, depending on the embodiment of this aspect of the present inventions.

As a result of the performing of the design activity in the first pass 31, information may be fed back to the predecessor activities 30. That is, the information learned in subsequent activities can be used to revise the result of earlier ones. For example, it may be learned in a later activity that a certain product feature is undesirable. This information may be fed back to the module where the priorities were set. The prioritization step may then be performed anew.

This permits a better informed process or activity. For example, other decisions made in a predecessor activity may be impacted by assumptions about what would happen in later activities. For example, one feature of a product may be regarded as particularly important because of the way it relates to others. If in subsequent activities it is determined that one of that feature set is not feasible, it may be desirable to eliminate not just that feature but others as well. In light of the elimination of that feature, it may also be desirable to substitute in a new feature or features. By passing the results of later activities back for consideration by earlier activities, a more informed process is allowed. This can save a substantial amount of time later (avoiding the need for a complete redesign, or at least identifying the need for a complete redesign earlier) and may also result in the development of a superior product.

After the information is fed from first pass 31 to linked predecessor activities 30, the updated information from the predecessor activities may be fed forward so that a second pass 33 may be performed for the activity.

Once the activity is completed at step 33, the information is fed to the successor activities 32. These activities may, for example, be specified in the dependency lists 21i of the templates shown in FIG. 2, in certain embodiments in the inventions described in the specification.

As described above with respect to step 31, the successor activities may feed information back from step 32 to step 33. With this information, a third pass 34 may be performed for this activity. The third pass is completed using the information and feedback determined from the successor activities.

At step 35, it is determined whether the success criteria are met. If not, then additional passes at the activity are necessary, and step 34 is repeated. Once the success criteria are met, at step 36, the activity is complete. That information is then fed again to the successor activities 32 where product development continues.

At step 37, immediately as well as at a later date, the results of the design process are analyzed and the data is put in a reference library 38. As described in greater detail below, this information may be useful as part of the ultimate evaluation of this product's success, and as feedback for future similar design projects.

At step 39, the processing of this particular activity is complete.

Example of a Development Process Incorporating Various Aspects of the Inventions.

Various aspects of the present inventions may be understood through an example of a simplified product management process according to one embodiment of various aspects of the inventions.

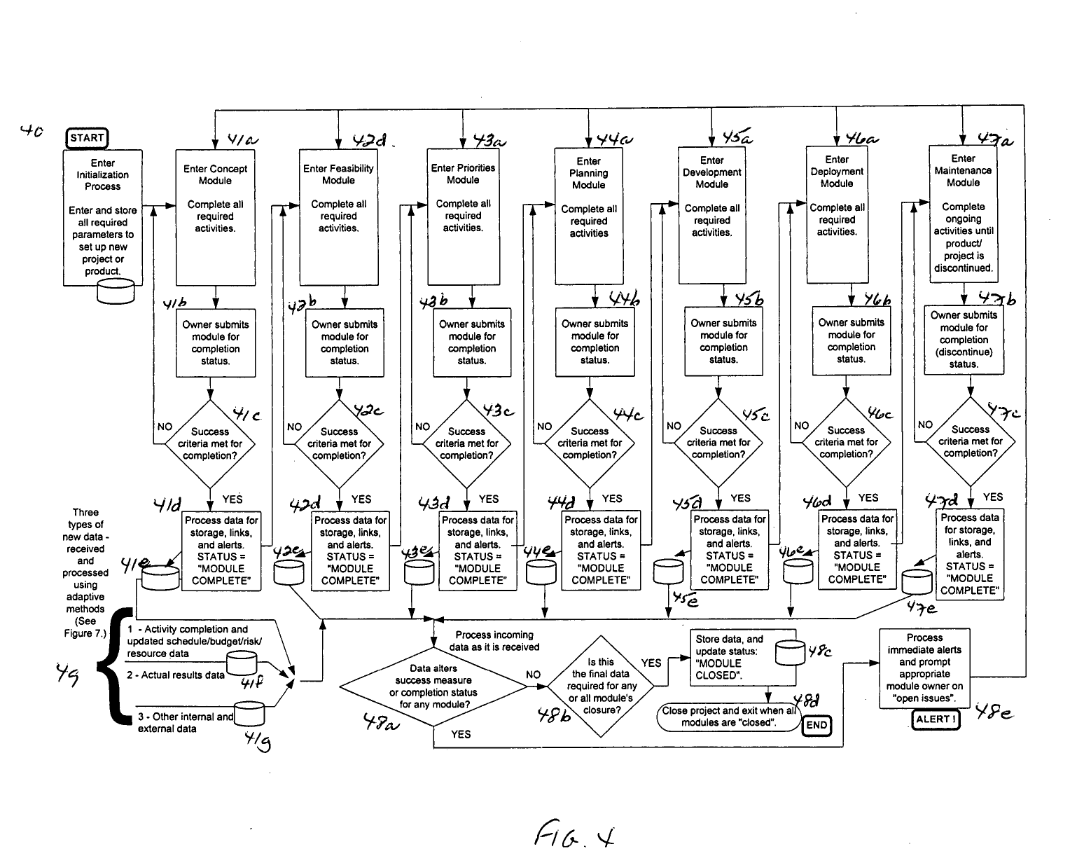

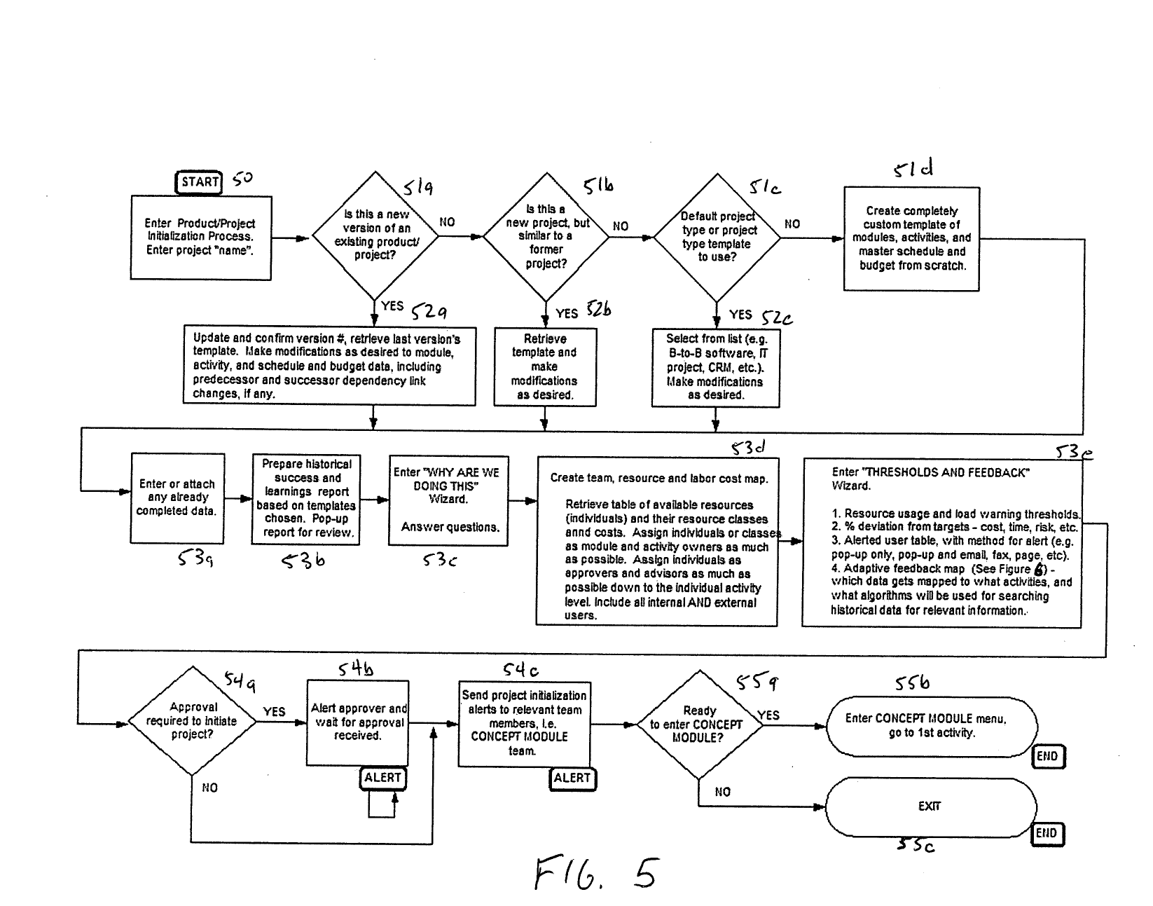

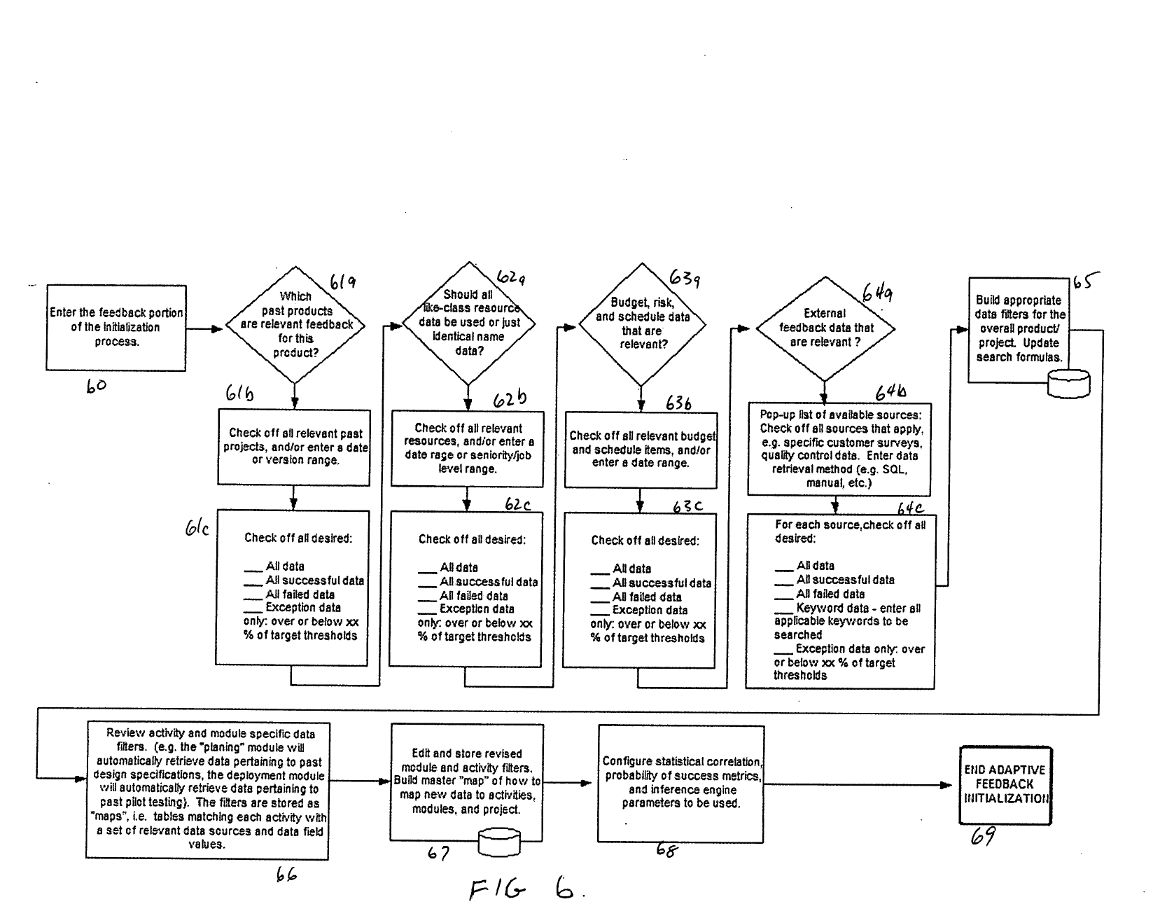

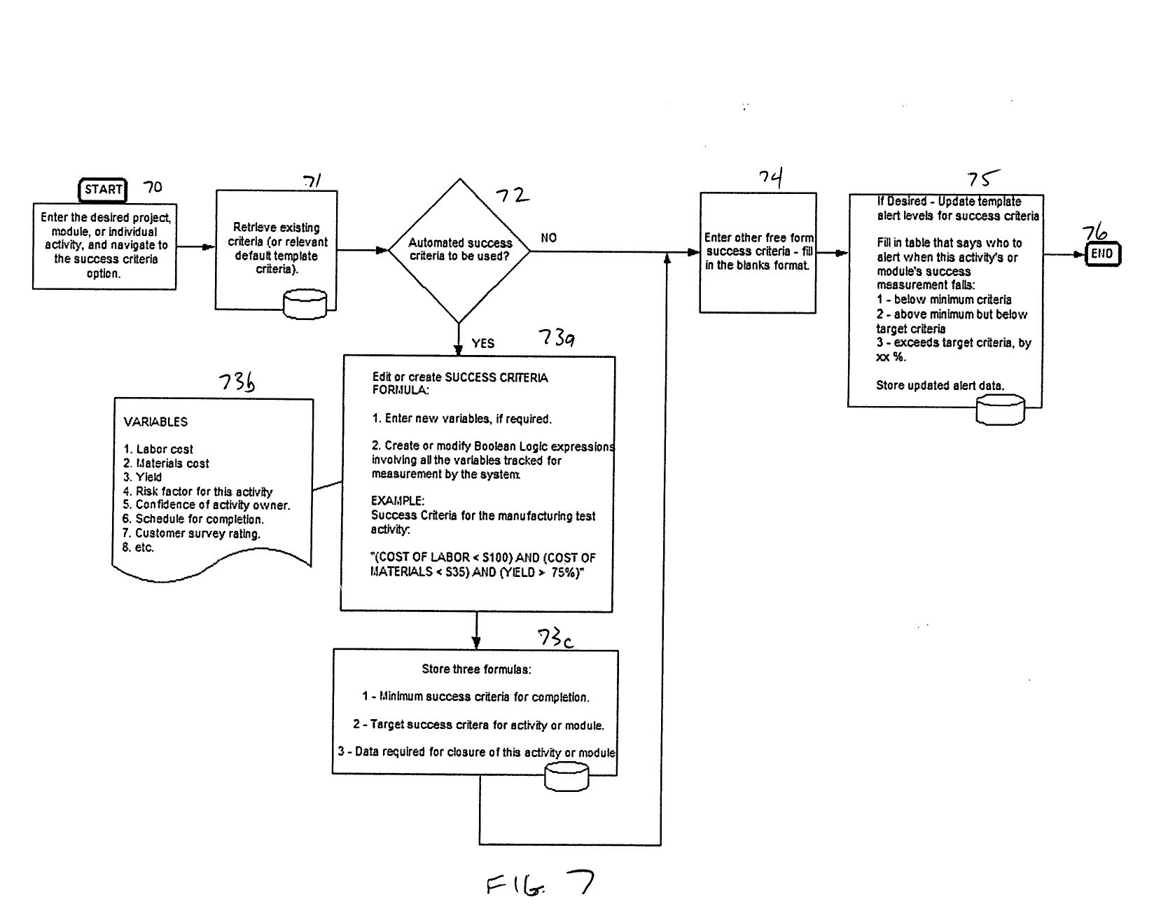

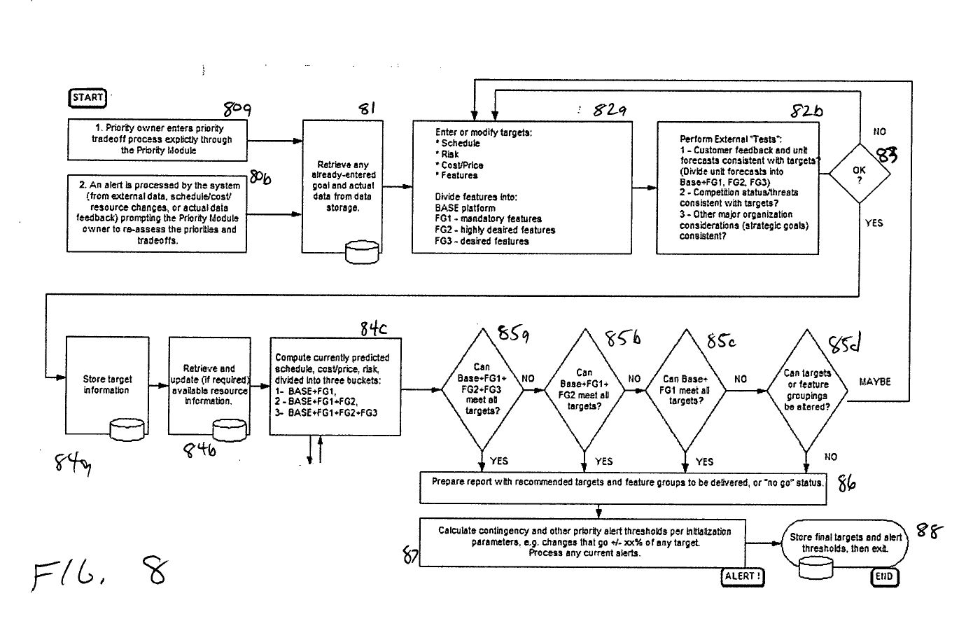

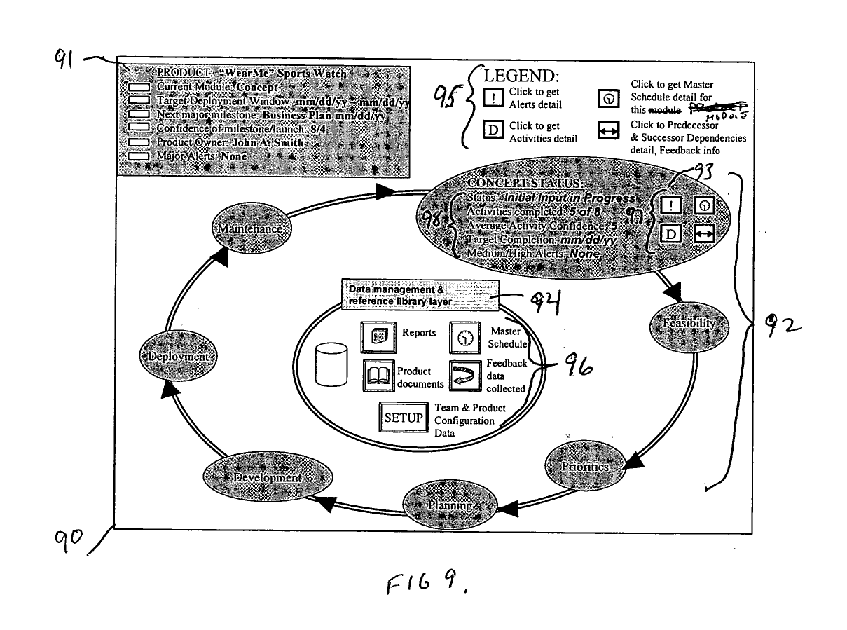

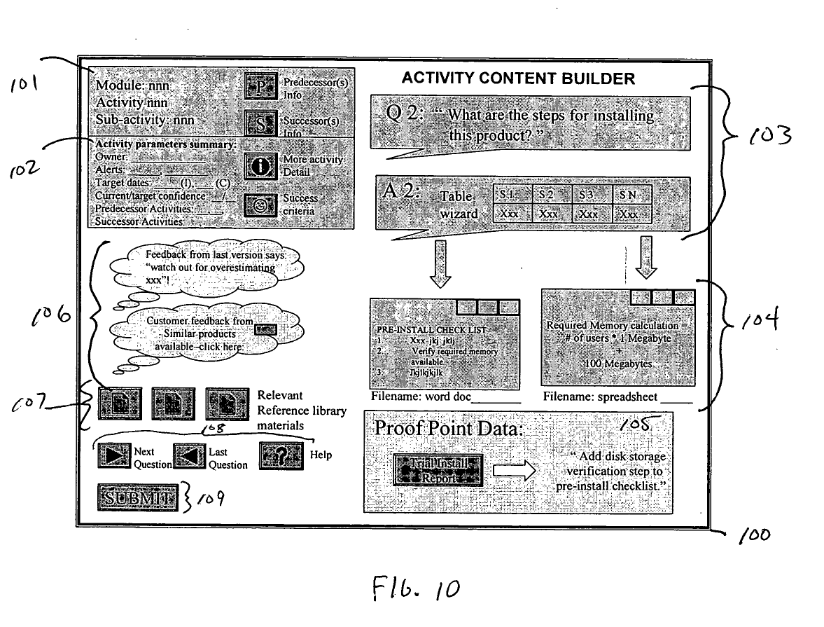

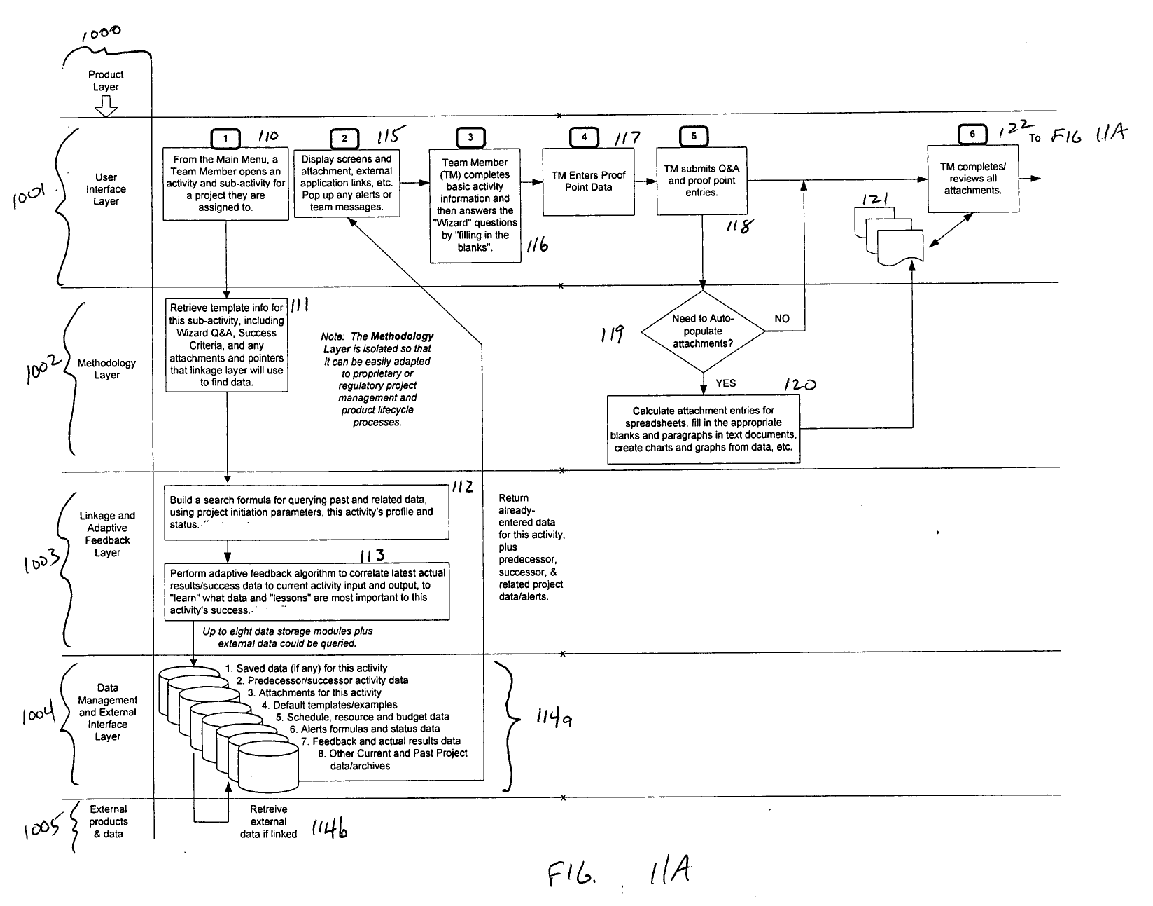

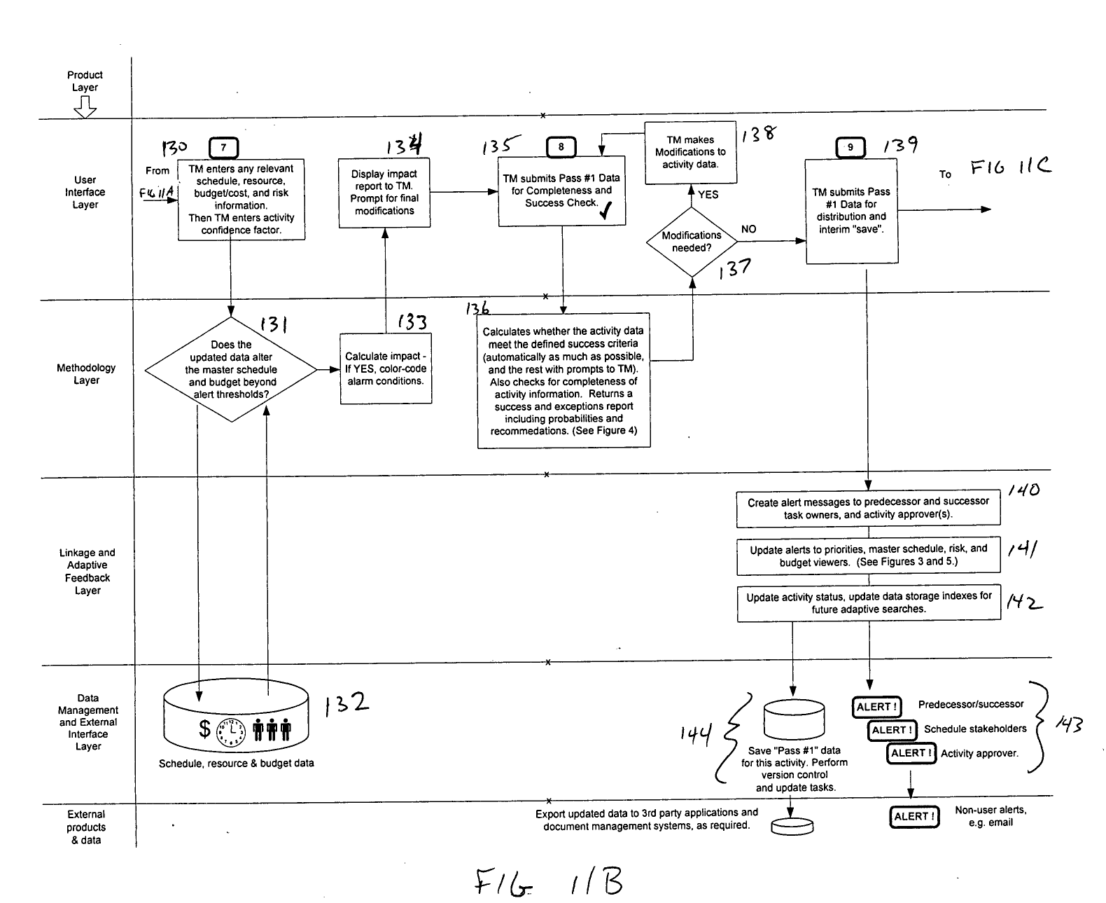

FIG. 4 illustrates one embodiment of a method implementing aspects of the invention. A description of this particular methodology assumes that it is implemented in software on a computer, although certain embodiments do not require this. As described with respect to this embodiment, however, implementation in software permits a number of advantages including the ability to update information automatically throughout each part the project.

At step 40, an initialization process for the new project is entered. In this embodiment, the initialization process sets up the general parameters for the project. As described with respect to FIG. 6, initialization may also include gathering of feedback data from other projects. Where this aspect is included, learning from previous projects may be incorporated into the activities for this project in a more coordinated and formal manner. This can assure that past experience (including past experience of others not necessarily on this team) is considered in the product management process.

FIG. 5 illustrates an example of project initialization for the embodiment described in FIG. 4.

At a step 50, the initialization process begins. A user is prompted to enter a name for the project, which may or may not be the product name.

At a step 51a, the user is queried as to whether this is a new version of an existing product or project. If so, there is an existing set of templates already in place for this particular project. Accordingly, if this is a new version of an existing product or project, existing templates may be used “as is” or updated to reflect nuances of this new version at step 52a. Modifications (in addition to version number modifications) may be made to the templates at step 52a, or as a part of the succeeding steps as described below.

In addition, end-point (or current) content entered into the templates from another project can be chosen to automatically populate templates for the new project, as a default. In this case, things like target schedules and other “no longer accurate” data may need to be modified, but other content data, like test plans, may be helpful and speed completion of many activities.

If this is not a new version of a product, at a step 51b, a user is queried as to whether this project is similar to a previous one. If so, the general structure of the templates for that project may be useful in structuring this project as well. Accordingly, if this is similar to a former project, at step 52b the templates are retrieved for that project and modified as desired for initiation of this project.

At a step 51c, it has been determined that this is not a new version of an existing product or similar to a previously performed project. Accordingly, the system queries whether there is a particular default project type or set of templates for use. This may, for example, be input through the use of pull-down menus or other mechanisms that permit a user to select from among the list of available default project templates.

This selection can be performed at a step 52c. The templates may be tailored for the different types of projects. For example, different default sets of templates may be suitable for small manufacturing projects, large manufacturing projects, retail products, software projects, etc.

If no default project templates are applicable, then at step 51b a custom set of templates is generated. These templates may be designed for the modules, activities, and sub-activities as can be determined at the initiation module.

After the applicable step 52a, 52b, 52c or 51d, processing continues at a step 53a. At step 53a, already gathered data is completed or attached to those templates that presently exist (new templates may be added during the course of the project, particularly when new sub-activities are identified). For example, the following might be attached:

a strategic plan for the entire company that mentions getting into this new business area as an approved step and this product is one of the ways mentioned. This would be part of the strategic and tactical fit activity within the Concept Module.

data from a similar project that is input manually—e.g., a budget for a product designed by others.

an industry analyst report on competition or the market that might have relevance (or that sparked the project concept in the first place).

At step 53b, historical success and learning reports, based on the templates chosen, are prepared. A report may be presented to the user for a review period. These historical success and learning reports are associated with the particular set of templates chosen. For example, if the design is a new version of an existing product, data concerning the success of that project and what was learned may be available. Similarly, if this is similar to a former project the success and learning reports can be presented up front for review by the person initiating the project.

At a step 53c, the user initiating the project enters a set of questions about why the project is being performed. These questions may be fed forward or revisited in the feasibility and priorities modules of the project. An up-front evaluation (and archiving) of the reasons for the project can be useful to make sure that team members have an opportunity to see the forest of the project and do not get lost in the trees of details, in the heat of the performance of the project.

At a step 53d, an initial cut is made at determining the project team, resources and labor costs. Where available, this may include retrieving a table of available resources (e.g., employees) and the applicable resource costs for budgeting purposes. To the extent possible at this module of the project, individuals may be assigned as owners of the modules and sub-activities that have been identified to date. Of course, these can be updated or changed as the project progresses, but preliminary assignment at this point allows people to take ownership over their tasks in the project and assure that they reserve time at the appropriate points. Similarly, the people necessary to approve or signoff on different modules and activities of the project may be put in the templates as well.

Much of what has been performed in steps 53a-53d includes updating of the content in particular templates that have been selected in steps 51a-52c. This content data may be input to templates directly, input as the result of question and answer (Q and A) wizards or through some other user interface. Examples of completion of (the content in) templates will be provided below.

At step 53e in this example, a thresholds and feedback wizard (e.g., question and answer) utility may be entered. In this context, “thresholds” refers to an initial input as to when a user alert should be issued. Feedback refers to generating feedback information for use in the development process based on past experience (as described below, for this example, with reference to FIG. 6). Of course, different orders and methods of input are appropriate. For example, the entry of threshold information could be done separately from the feedback information, and in other embodiments neither of these steps could be performed.

For entry of threshold information, a variety of mechanisms can be used in order to specify when to trigger an alert. One is if the amount of resources dedicated to a particular module or sub-activity exceeds a certain level. Another would be where the cost, time, or risk, deviate a certain amount from the target or surpass a particular threshold. For each of the applicable warnings, the user or users to be alerted are also identified as well as the method of alerting them. For the latter, pop-up notices, e-mails, faxes, etc. could be used to identify the appropriate user that an alert threshold has been exceeded.

In this particular example, steps 50-53e represent a first cut at the planning process and also a first cut at completing at least certain of the information for a set of templates for the project. As noted above, the template information and the templates themselves may be modified as the project develops and additional templates may be added as additional dependencies and sub-activities are identified.

In a step 54a, it is determined whether approval is required to initiate the project. If not, processing will continue at step 54c. If so, approval is obtained at step 54b. Of course, if the matter is not approved, the project should not move forward.

At step 54c, the project has been approved (or approval is not necessary) and the project may be started. Accordingly, the relevant members of the team are alerted.

Initially, as illustrated in FIG. 4 at step 41a, the Concept Module team is alerted. At a step 55a, it is determined whether the Concept Module is ready to be entered and the project is officially (and in this embodiment automatically) moved into the Concept Module status. If not, at step 55c, the project is on hold and the user is returned to a main menu or exits the system. If so, at step 55b, the Concept Module is entered and the user may begin completing the content for the Concept Module.

Gathering of Historical and Other Feedback Information

As described above, one method of feedback from previous projects is selection of the appropriate templates for the new project. If a previous project is selected, information in those templates may be retained which will pass information from that project directly to the new project. As a part of the initialization project, or later, the user may always remove that information.

The default templates may also include additional data filters to permit queries of a large database for relevant information to generate historical data. For example, the project templates for a software development product may include queries for a database of software vendors. This would permit all data gathered in other projects concerning software vendors to be gathered as a linked resource on those templates where software vendor information may be helpful. When data is learned about new software vendors in any project, the database may be updated with information about those vendors and all projects that need information about software vendors may retrieve this information as a part of a default (or later specified) query to the database.

FIG. 6 illustrates one embodiment of a method for gathering feedback data from previous projects and other sources for initialization of a development project.

In one embodiment, the default templates may include recommended vendors for services. Since the recommendation of a vendor to a person performing a project is a particularly powerful advertising tool, a number of facilities could be built around the recommendation of vendors. For example, a qualification process may be required before a vendor is included in a default template (or in a reference database).

Where a system is implemented in software and sold or leased for third-party use, vendors could be offered an opportunity to purchase advertising space in the default database or pay to be placed into one or more sets of default templates. In this embodiment, sale of advertising becomes a further source of revenue for the software provider.

When an activity is entered, including at the time of initialization of the project, an adaptive feedback algorithm may be performed. When this occurs, the system once again queries all relevant databases to gather resources for reference during the applicable part of the product management process.

In FIG. 6, at step 60, the feedback portion is begun. In steps 61a-64c, the range of potential information for linking is successively narrowed to generate a set of queries or filters to retrieve the desired data.

At step 61a the user is queried about past products that have relevant feedback for this product. At step 61b, all of the relevant past projects (and date or version ranges, where applicable) are identified. For each, the user then (at step 61c) identifies whether to link all data, all successful data, all failed data, or only exceptions (e.g., where things fell outside of a particular threshold for success) for this class of information.

As described below with reference to steps 65-68, the identified data is then linked to the applicable templates for the new project, thereby making that data available to all users during the project.

At step 62a, the user is queried as to whether to include information about all resources within the identified relevant past projects and/or filtering based on job type. For example, there may be information about potential manufacturers that may be useful for identifying quality and cost information about those manufacturers.

If the user wishes to link feedback from classes of resources, or only identical name resources, the user identifies at step 62b the relevant resources and/or the applicable data ranges or seniority/job level range (such as retrieving only module level information rather than all activity level information). (“Resources” refers to any resource that can be identified at the time that the feedback processing is occurring for the current module of the project. For example, the resource could be an employee that will be completing certain tasks, a manufacturer that might be considered, suppliers for product components, etc.) Once again, having this information ready at hand as part of the design process permits not only more efficient planning of resources and completion, but also guarantees that these things will be considered as a part of the product management process.

At step 62c, the user specifies the types of data within this range of classes to be gathered for the applicable resources.

At step 63a, it is determined whether budget, risk and schedule data in the system is relevant. At step 63b, the user identifies those relevant entries and, at step 63c, determines what type of data to gather.

Finally, at step 64a, it is determined whether there is external feedback data that may be relevant. At step 64b there may be a list of available reference materials. Of course, the user may also specify other available datasources. At step 64c, the user identifies queries or the types of data to be gathered.

At step 65, the planning for gathering of feedback information is performed. This step may include developing the appropriate data filters or queries in order to search a database of information.

For example, if it is determined that a 2002 dress lady's watch and a 2001 skin diver watch are two relevant products to consider for the new project of creating a general purpose man's sports watch, not all of the data from those two efforts will be relevant. Information pertaining to any past marketing tasks associated with co-promotion of other women's sporting goods, and any past budget analyses related to fine jewelry decorations, would be irrelevant and might even cloud statistics about important relevant data, such as the cost for water proof materials, and the fact that men have preferred large numbering on the watch faces. In step 65, maps and queries may be built to retrieve the data and place it into tables that may be searched when relevant activities are performed. For example, when the user of the invention enters a budget activity and must enter cost, the costs for the previous water proofing watches may automatically appear on the screen as a “relevant feedback data item,” but the costs for jeweled watches would not. Likewise, when a team member begins a prototype phase, the mock-up instructions wizard may include a feedback entry including a recommendation to use oversized fonts for the watch face numbers. A user may augment or override this adaptive feedback suggestion, but it would have been automatically retrieved from the adaptive feedback tables based on the filters identified in step 65.

Thus, filters and data maps are constructed automatically based on the answers in steps 61-64. The user can view this data and then modify the queries and maps even further. In the above example, the query could include a search where [PAST PRODUCT=“2001 SKIN DIVER WATCH” OR “2002 DRESS WATCH”, AND RELEVANT DATA KEYWORDS=“MENS” OR “DESIGN FEEDBACK”, OR “WATER PROOFING COSTS”, etc.

Queries may be constructed using keyword searches or specific joins and other Boolean logic queries based on a template database schema. A schema query, for example, could be much more specific than a keyword search and could, e.g. find all bills of materials where water proofing was used. After step 65 is complete, the relevant data is available for use in the project and stored for quick retrieval.

At step 66, activity and module specific data filters are updated. The data that has been deemed relevant is mapped to each module and activity to which it applies. For example, at the appropriate planning phase, past design specifications may be identified for retrieval. The user may add or remove links between feedback data and particular module and sub-activities. For example, the design specification for the dress watch may be relevant, but for some reason the design specification for the skin diver watch may not be desirable for review by the new project team.

At step 67, the filters may be reviewed and edited. Once finalized, the filters and data maps may be stored as a part of the templates. Thus, when the template is activated or updated, new information can be appropriately updated as a part of the development process and presented to users for consideration.

At step 68, statistical correlations and probability of success metrics can be formulated. This can be done by correlating the retrieved information with successful and failed projects, or determining whether there are any anomalies or problems in the product management process. While this can be done manually, the probability of success for past activities or team members could also be computed and projected into the performance for this project. Likewise, the specific activities and their associated data which are most likely to determine success or failure can be computed. In embodiments where this is done, a variety of known mechanisms may be selected for application to this task, such as using keyword searches, neural network algorithms, rules-based expert systems, fuzzy logic, etc.

The following table is a simplified example of the content for a success and learnings report for a sports watch product. In this example, scores are used to rate the success of a particular activity. Here, the following scoring system was used: EE=Exceeded expectations; ME=Met Expectations; UE=underperformed expectations; AA=Above average; AV=Average; BA=Below Average.

In this example, two types of historical information are included. Automated learning entries correspond to information that may be calculated automatically from the previous project data. For example, it is possible to determine automatically whether the original time to market goals were met and, if not, by how far. Subjective learning entries correspond to the subjective impressions of team members or others who provide feedback on the project for use in future projects.

| | SCORE | | | |
|---|---|---|---|---|
| | (compared to | | | |
| | target/compared | | | |
| | to related | | AUTOMATIC | SUBJECTIVE |
| CRITERIA | project average) | Exception Summary | LEARNINGS | LEARNINGS |
| Features (click | ME/AV | None | None | Choice of battery type |
| here for details | | | | did not consider |
| on the 7 features) | | | | availability - it is a rarer |
| | | | | type and not carried by |
| | | | | most of our standard |
| | | | | retailers. |
| Time to Market | UE/BA | UE: Time of market | While all seven priority | The team did not heed the |
| | | launch was 2 months, | features were included, | alerts provided by the |
| | | or 20% later than the | the time to market | system, and instead |
| | | target, and 10% later | slipped below targets, | “hoped” they could gain |
| | | than the worst case | and the contingency | back lost time during |
| | | contingency target | plan to remove priority | testing. Had the alerts |
| | | BA: The average for | 7 “alarm” features was | been followed, this |
| | | the organizations time | not adopted when | product would likely |
| | | to market slips is 5%, | suggested at the alert | have met or exceeded all |
| | | putting this slip below | trigger. | success criteria. |
| | | average | | |
| Cost | ME/AA | AA: This project's | | Cost containment was |
| | | cost was within 5% of | | well controlled through |
| | | target, which met | | weekly updates to bill of |
| | | expectations of 5%, | | materials during the |
| | | whereas the average | | development phase, and |
| | | cost is higher by 10% | | pre-negotiated overseas |
| | | over target. | | manufacturing labor rates |
| | | | | that were 5% lower than |
| | | | | domestic rates. |
| Price | ME/AV | None | None | |
| Risk and Quality | ME/AV | None | None | |
| Other - | ME/AA | ME/none to compare | None | Executives added a |
| Demonstrating | | | | success criteria for |
| capability to | | | | having manufacturing |
| manufacture | | | | overseas. This is the first |
| overseas | | | | such product for the |
| | | | | organization, and this |
| | | | | aspect of the project was |
| | | | | carefully planned, and |
| | | | | was executed |
| | | | | satisfactorily. |

Templates

Returning to FIG. 4, after the initialization step, a set of default templates is provided. A highly simplified partial set of templates is presented below with respect to each module of an example project—a new sports watch. In this example, there is some information available from the design of a dress watch product that the same company had introduced to market a year earlier.

At step 41a, the Concept Module of the project is initiated. Table 1 shows a simplified template for this module:

TABLE 1
Concept Template Example

| | |
|---|---|
| Activity Name | Sports Watch 1000 - Concept Module |
| Revision Label | Version 1.0 |
| Activity Owner | Project Manager |
| Team Members | Project Manager; Employee A |
| Inputs | None |
| Feedback information | [Information gathered during initialization and presented |
| | as fields or folders with information from other projects |
| | and other sources; this may include, for example, the |
| | Concept template (with answers to Q&A) and the concept |
| | statement from an earlier development project for a dress |
| | watch.] |
| Q&A | [Q&A's for formation of this project or type of project, |
| | such as identification of targeted consumers, distribution |
| | channels, preliminary budget for project, market analysis |
| | for the watch, etc.] |
| Proof Points | [Q&A's about Concept, such as comparison of the time |
| | frame for this project with the time required to complete |
| | similar projects] |
| Deliverables | Link to Sports Watch Concept statement document |
| Dependency Lists | [Answers from the Q&A are fed forward to modules |
| | needing information such as who the targeted customers |
| | are] |
| Criteria for success of this | VP approval |
| activity | |
| Pointers to reference | Links to competitive products |
| materials | |
| Activity Success | 7/10 |
| Confidence Factor | |
| Sign off | VP Sign Off Required |
| Alerts | No sign off by mm/dd/yyyy. |

In this particular (simplified) example, the Concept Module has no express activities. In reality, the Concept Module may call separate activities, such as a Product Definition activity. In that case, for example, the Q&A section of the module may ask if the Product Definition activity is complete. Answering this question would invoke a new template for the Product Definition Activity which would assist the team member to build the content for the product definition. In certain embodiments, the deliverable of this activity might be a product definition statement which is automatically generated based on the content input as a result of processing the Product Definition Activity. This result may then be fed forward to the Concept Module template, to fulfill a deliverable for it.

In this example, the template set up by the initialization module includes the various fields (with the ability to add new ones, i.e., the ability to customize for this project; in certain embodiments, the ability to customize may be limited to certain users or classes of users). In addition, the content for the template may be partially completed as a part of the initialization process. For example, the owner of the Concept Module, and the team members, may be filled in as a part of initialization. When the Concept Module is entered, if this information is blank, the user is queried to complete. If the information is present, the user still has the opportunity to alter it.

At the initialization phase, the default questions and answers for the Concept Module are included. At step 41a of FIG. 4, the user answers the applicable questions for the Concept Module.

At step 41b, the owner of the Concept Module (in this example, the Project Manager) submits the module (or template) for completion. When this is done, the module (now stored as a completed template) is tested for success, at step 41c.

FIG. 7 illustrates a generic example of creating the success criteria for the completion of a module, activity or sub-activity. This process may be invoked in the initialization phase for the project, at the opening of the particular module, activity or sub-activity, or (at a minimum) before its completion.

This process can be used to create criteria for test completion of the Concept Module in this example, and may also be used to test criteria for success of the other modules and any separate activities or sub-activities invoked by them, as illustrated at Steps 41c, 42c, 43c, 45c 46c, and 47c of FIG. 4.

In FIG. 7, the particular module of the desired project is called. In Step 71, the applicable success criteria for this particular module and its activities are retrieved. This information may be stored as a part of the applicable template for the module or activity being submitted for review.

At a step 72, it is determined whether automatic success criteria are to be used. If not, at step 74, the success criteria for this particular activity is updated manually.

If automatic success criteria are to be used, then at Step 73b, a success criteria formula is created or edited (or retrieved from the default template). The success criteria may include a number of variables and a Boolean expression that determines a true or false value for success. For example, for the manufacturing activity, there may be a Boolean expression pertaining to the cost of materials and the yield of the manufacturing process or quality. Only if each is met is the success criteria satisfied. The potential variables that may be input to the success criteria can be input at 73b from among a list of possible variables.

At step 73c, the success criteria are evaluated. In this example, the success criteria include three calculations—minimum successful criteria, targeted criteria, and data required for closure. For example, in the Concept Module from above, a concept statement may be required for closure of this activity. If automated success criteria are used for that particular value, the system would test to assure that a concept statement is in place. If so, that aspect of the success criteria would pass. If not, it would fail.

Other automatic criteria could be the approval of a certain user, e.g. VP, who must enter his/her approval for this activity after reviewing its outputs, proof points, and other related information. The system may automatically check that this approval was in fact secured.

Even where automatic success criteria are used, the user is queried to enter other free-form criteria. In this embodiment, the query assures that the user is offered an opportunity to consider other definitions of success in connection with this particular development process.

At step 75, the alert levels for success criteria (once measured for this activity) may be set or altered. These alerts may trigger notification to others that, e.g. the success criteria has exceeded targets or has failed by more than a certain threshold. For example, if the delay is too great, the cost too high, or a concept statement has not been completed, an alert may go to the identified party.

At step 76, the template is updated with the results of the success criteria formulation and processing returns to that module or activity (or initialization process) that spawned the consideration of success criteria.

Returning to our Sports Watch example, the Concept Module is tested to see if the success criteria is met and whether any alerts are triggered by the completion of this module.

Returning to FIG. 4, step 41c, if the success criteria are not met, processing returns to the Concept Module.

(Although this is described as linear, many aspects of the activity processing may proceed in parallel. For example, even if the Concept Module has not been marked as complete, activity may be proceeding for any other activity where sufficient predecessor information is available to begin processing. Where this aspect is employed, a far faster design process is possible since the maximum number of possible activities may proceed in parallel. On the other side, however, modules and activities may not be formally “closed” until the product is marked as closed. Thus, the Planning Module may be completed (and marked as completed) after a first, second or third pass, and still be re-entered if new feedback becomes available or a change in a successor or predecessor activity triggers consideration of one or more activities within the module.)

If the success criteria have been met, the data is processed, and stored as shown at 41d and 41e of FIG. 4. Part of the processing includes passing the deliverables forward to the other modules and sub-activities via the templates associated with each and modifying status and summary report data.

As shown at 49, feedback data is again queried to determine whether additional feedback information should be associated (and, in some embodiments, automatically brought to the attention of the applicable team member(s)) with the applicable templates for each of the other modules and sub-activities in the project. Although illustrated as a separate test, this may be monitored in the background and further processing triggered preemptively when new data or information becomes available.

The product management process may then proceed into the Feasibility Module as described generally above and shown at step 42a of FIG. 4. In the Feasibility Module, a second template (also set up as a default or custom template from the initiation phase) is completed. Table 2 shows a simplified example of this template.

TABLE 2
Feasibility Template Example

| | |
|---|---|
| Activity Name | Feasibility Module - Sports Watch |
| Revision Label | Version 1.0 |
| Activity Owner | Project Manager |
| Team Members | Project Manager; VP manufacturing; VP sales |
| Inputs | Concept Statement [from Concept Module]; |
| | Market Size [from Concept Module Q&A]; |
| | Target Price Range [from Concept Module Q&A]; |
| Feedback information | [Information gathered during initialization and presented |
| | as fields or folders with information from other projects |
| | and other sources; this may include, for example, |
| | feasibility studies with manufacturing costs, etc.] |
| Q&A | [Q&A's for feasibility study, including raising all potential |
| | issues that could be a show-stopper for the project, such as |
| | third-party intellectual property blocking sale of this |
| | product or failure of a preliminary marketing study.] |
| Proof Points | [Q&A's about Feasibility, such as securing information |
| | about manufacturing cost of a similar product] |
| Deliverables | Estimate of likelihood of project feasibility |
| | Business Plan with estimated revenue, cost, pricing, etc. |
| Dependency Lists | [Answers from the Q&A are fed forward to modules |
| | needing information such as who the targeted customers |
| | are] |
| Criteria for success of this | CEO approval |
| activity | |
| Pointers to reference | Links to competitive products |
| materials | Links to manufacturers |
| Activity Success | 8/10 |
| Confidence Factor | |
| Sign off | CEO Sign Off Required |
| Alerts | No sign off by mm/dd/yyyy. |

Returning to FIG. 4, the owner of the Feasibility Module (here, the Project Manager) submits the feasibility module for completion, at step 42b. At step 42c, the success criteria are evaluated; in this embodiment, the success criteria can be processed (or formulated) as described above with reference to FIG. 7 and evaluated as described in FIG. 4. One success criteria for the Feasibility Module is verification that all of the identified project risk factors have been considered and the project is still believed to be feasible. A requirement that manufacturing cost be less than $X is a more specific possibility.

If the success criteria are passed, processing continues at step 42d. If not, further work on the Feasibility Module must be performed at step 42a.

As described above with respect to FIG. 3, in certain embodiments of the present inventions, the completion of a first pass at the feasibility module may trigger a second pass at the Concept Module. For simplicity, the remainder of the discussion of this embodiment will omit discussion of additional passes at each module (or even activity) of the completion of the product.

On completion of the Feasibility Module, as for the Concept Module, the process stores updated data which may trigger further information from the feedback loop as shown at 49, as well as new processing for alerts, etc.

At a step 43a, the Priorities Module is begun. Table 3 illustrates a simplified template for the Priorities Module:

TABLE 3
Priority Template Example

| | |
|---|---|
| Activity Name | Priorities Module - Sports Watch |
| Revision Label | Version 1.0 |
| Activity Owner | Marketing director |
| Team Members | Project Manager; VP manufacturing; VP sales |
| Inputs | Concept Statement [from Concept Module]; |
| | Marketing Analysis [from Concept Module]; |
| | Business Plan [from Feasibility Module] |
| Feedback | [Information gathered during initialization and presented as fields |
| information | or folders with information from other projects and other sources; |
| | this may include, for example, feature lists from the dress watch |
| | designed before.] |
| Q&A | [Q&A's for priorities - sample below.] |
| Proof Points | [Proof points for some or all of the data points from the Q&A |
| | section - sample below.] |
| Deliverables | Product Requirements Statement; |
| | Preliminary Master Schedule and Budget |
| Dependency | [The product requirements statement and the Master Schedule and |
| Lists | budget are fed forward to the planning module where a detailed plan |
| | is formulated.] |
| Criteria for | Completion of this activity to confidence level 7, by mm/dd/yy; |
| success of this | The Master Schedule indicates that the minimum required feature |
| activity | set is doable within the time to market and price/cost windows stated |
| | in the business plan. |
| Pointers to | Market size report from an independent analyst; |
| reference | Letters from key customers who have requested specific |
| materials | features |
| Activity Success | 3/10 - At this time, author feels the data is preliminary, and the main |
| Confidence | market size analyst report is dated. Usage cases and competitive |
| Factor | landscape feedback will confirm the analysis here. |
| Sign off | (Director of Product Management) and VP of Marketing sign off for |
| | this activity; |
| | all backward dependencies must be completed; |
| | Confidence factor must be 7 or above. |
| Alerts | Predecessor activities incomplete as of mm/dd/yy, alert activity |
| | owner; |
| | Initial input by owner not complete by mm/dd/yy - alert VP |
| | Marketing; |
| | Initial input by owner not complete by (later) mm/dd/yy - alert |
| | CEO; |
| | Linked successor feedback (e.g., to allow a third pass in |
| | accordance with FIG. 3) not received by mm/dd/yy, alert all |
| | team members |

A sample Q&A for this example could be as follows.

1. In order of priority, list the features required for this product to be successful in the defined market?

(A sample answer for a sports watch product:

Priority 1 Feature: keeps accurate time, within xx seconds per year.

Priority 2 Feature: waterproof to xx meters

Priority 3 Feature: Second hand and timer

Priority 4 Feature: comfortable wrist bands, fits all size wrists, ages 10+

Priority 5 Feature: user-adaptable—no service required (battery and wrist band)

Priority 6 Feature: space for third party logo on watch face (e.g. branding partner)

Priority 7 Feature: Alarm feature.)

2. Group the features into two or more buckets for contingency releases, with the first bucket being the “minimal required feature set for success”.

3. How will the customer use the product most? (List all main use cases that need to be defined in detail.)

4. How must the product be packaged and configured? Why?

5. What services must be offered to make the product successful? (List training, documentation, installation, etc.)

6. What time to market is most desired? What is the latest time this product can be delivered? (To establish a risk window.) List in priority what factors are most important in time to market: competitive entry, seasonality, wave of purchasing power or interest, sales partner coordination, etc.?

7. At what price must the product be sold to be successful (min and max used for risk management)? How many must be sold at these prices?

8. Given this price window, at what maximum cost must the product be produced? What is the desired cost target?

9. Provide a discounted cash flow statement, ROI, and payback period for this product.

As may be appropriate, the owner may assign tasks from this list to others or may spawn new sub-activities with their own templates, with the result to be fed-back to this module. Another frequent input to the Priorities Module is the formation of an advisory panel for the project.

An example set of proof points for question #1 above is as follows:

Attach to each feature any known customers requesting it, and the revenue associated with these customers should this feature be made available.

Attach overall market revenue and number of customers with their average sale price who are attached to this feature, and the justification/sources for these numbers.

Proof points may also be included for the other questions above as well.

For Table 3, a preliminary Master Schedule and Budget is specified as one of the deliverables for this project. A default template may be provided for the Master Budget and Schedule or it can be generated from scratch in this module.

The Master Schedule and Budget includes a schedule and budget for the project as a whole and each of the identified sub-tasks. Since the Planning Module has not been completed when the first pass through the Priorities Module is performed, completion of the Master Schedule and Budget may be, at this point, quite preliminary. For the project and each module (and sub-activity), the Master Schedule and Budget may include the following information:

name of activity, module or project;

estimated and actual duration; resource class for activity (e.g., completion by employee, subcontractor, etc.);

estimated and actual cost (including human resources, materials and other expenses);

dependencies on predecessor and successor activities and other constraints;

status;

currently estimated and actual completion date;

risk level;

confidence of owner in successful completion;

comments; and

pointers to relevant reference data and template.

At the priorities stage, most of the “actual completion date” entries will be blank, but (as with all of the other fields) may be updated in later stages of the product development cycle. As each activity has its own template, the Master Schedule and Budget can be built into the templates for the modules and sub-activities or maintained as a separate linked (or other) data structure.

In Table 3, the success criteria may result in a design process which iteratively converges on a feature set that meets the various design criteria. That is, the success factors may require that a feature set be selected which meets the marketing goals/targets as well as the manufacturing (e.g., cost) and time to market factors.

FIG. 8 illustrates one embodiment of a method for managing priority or feature tradeoffs in formulating a product, which may be implemented in some embodiments of the present inventions. As for the other steps described in the specification, the steps can be performed manually but a number of advantages may be achieved if implemented in software.

There are two potential entry points for calling this particular methodology. As illustrated at step 88, the Priority Module may call the priority tradeoff process directly. That is, once a feature set is input, (e.g., in response to a Q&A session), the actual features to be designed into the product are selected.

As illustrated at step 80b, it is also possible to reenter the priority tradeoff method in response to an alert or determination later during the design, development or test market processes that the feature set needs to be reevaluated. This may occur, for example, when the cost structure for designing a feature into a product has increased beyond the highest acceptable target, and that the total cost is now over target. Once this occurs, the present selection of features may no longer be optimal. In this event, the template for the Priority Module may be reexamined to assure that the final feature set and other product parameters are valid and approved.

In either case, at step 81, all of the previously entered data from (if any) for the potential features or priorities are retrieved.

At step 82a, the particular targets for the design process are entered or modified. These targets include scheduling information, acceptable risk, acceptable cost and price for the product and the feature set. As indicated at step 82a, the features may be divided into different classes. In this example, the classes of features include base or platform features. For example, for a sports watch, it may be necessary to have some mechanism for attaching the watch to a wrist, it must hold time, etc.

A second class of features includes mandatory features for the product, but features which are not necessarily part of a base unit. For example, it may be mandatory that the sports watch be waterproof, even though this is not part of the base platform for the watch.

As indicated at FIG. 2, there may be highly desirable features. For a sports watch, this may include a timer. It is highly desirable but perhaps not essential for a sports watch. Last, are FIG. 3, or simply desired, features. Those features determined to be undesirable features may be pruned, although archived for future use in other design processes.

Of course, other mechanisms may be employed for classifying or weighting features. For example, each feature could be assigned a relative weight depending on its importance.

At step 82b, certain tests may be performed to ascertain further information about the relative desirability of the different features based on factors external to project execution. For example, as step 1 within 82b, customer feedback may be used to derive unit forecasts based on different combinations of features. Since both the base platform and FIG. 1 are mandatory, these may be considered as a unit—allowing forecasts for products that include both base and FIG. 1 features, no others. FIG. 2 and FIG. 3 features may also be incorporated. For each possible set of feature combinations the relative merits are assessed, based on (for example) the potential impact of strategic and tactical concerns (from the Concept Module) and/or project parameters (such as relative importance of time to market).

If the various feature sets appear to present at least one product that is consistent with the targets for the project, processing continues at step 84a. Otherwise, further analysis needs to be performed at steps 82a and 82b.

At step 84a, the target information is stored. At step 84b, available resource information is retrieved. This information will be used to ascertain the resources available in order to complete the design process given the various feature sets.

At step 84c, a schedule, cost/price, and risk factor analysis is performed for the various possible feature sets, including base plus mandatory features, base/mandatory and highly desired features and base/mandatory/highly desired and undesirable features.

At steps 85a-85c, it is determined whether the various product design possibilities can meet the design goals for the project. Where the various features are weighted, a comparison of the impact of adding features to the cost can be weighed with the best solution selected.

If one of the designs meets all of the particular targets, then a report can be prepared recommending the targets and feature groups to be delivered. If none of the groups meet all of the targets, but they may be altered in a way that could meet the targets, at step 85d processing is passed back to steps 82a and 82b to assess or analyze new potential combinations of features. If no other groupings can be tested, then the project development cycle has reached a crisis point—no available product design appears to meet the targets within the acceptable performance (e.g., costs) ranges.

At step 87, contingency and other priority alert thresholds may be determined. For example, it may be determined that if the cost calculation in the future exceeds a certain percentage of the target, an alert may be sent to all team members or to a selected group of advisors (or some combination thereof). This may, for example, trigger a new set of trade offs among product features.

At step 88, the process is ended and final targets and alert thresholds are stored.

Although this has been described as a formally automated process, it can similarly be performed by hand in using various mathematical or other algorithms to enumerate possible designs and examine them.

Returning to FIG. 4, after the Priorities Module has completed successfully, the project development process enters the Planning Module, at step 44a. As for the other modules, the owner submits a module for completion processing, at step 44b. Table 4 below illustrates a sample template for a Planning Module.

TABLE 4
Planning Template Example

| | |
|---|---|
| Activity Name | Planning Module - Sports Watch |
| Revision Label | Version 1.0 |
| Activity Owner | Project Manager |
| Team Members | Project Manager; VP manufacturing; VP sales; Employee A; |
| | Employee B |
| Inputs | Concept Statement [from Concept Module]; |
| | Marketing Analysis [from Concept Module]; |
| | Business Plan [from Feasibility Module]; |
| | Product Requirements Statement [from Priorities Module]; |
| | Preliminary Master Schedule and Budget [from Priorities |
| | Module] |
| Feedback | [Information gathered during initialization and presented as fields |
| information | or folders with information from other projects and other sources, |
| | such as detailed design drawings for similar features in other |
| | products, marketing plans from other products, etc.] |
| Q&A | [Q&A's for planning, to generate deliverables below; many of the |
| | questions spawn sub-activities which each have templates of their |
| | own that include a deliverable to the Planning Module.] |
| Proof Points | [Proof points for some or all of the data points from the Q&A |
| | section.] |
| Deliverables | Functional specification; |
| | Detailed design drawings; |
| | Micro-level work break-down for base and features; |
| | Marketing, sales and distribution plans; |
| | Operations plan (to specify how project is completed and |
| | fulfilled) |
| | Complete Master Schedule and Budget |
| Dependency | [The Product Development module will have sub-activities relying |
| Lists | on the foregoing deliverables.] |
| Criteria for | Completion of this activity to confidence level 7, by mm/dd/yy; |
| success of this | The Master Schedule indicates that the minimum required feature |
| activity | set is doable within the time to market and price/cost windows stated |
| | in the business plan. |
| Pointers to | Vendor lists with cost information |
| reference | Resource descriptions for marketing |
| materials | |
| Activity Success | 3/10 - At this time, author feels the data is preliminary, and the |
| Confidence | design unproven or tested. |
| Factor | |
| Sign off | (Director of Product Management); VP of Manufacturing; |
| | all backward dependencies must be completed; |
| | Confidence factor must be 8 or above. |
| Alerts | Predecessor activities incomplete as of mm/dd/yy, alert activity |
| | owner; |
| | Initial input by owner not complete by mm/dd/yy - alert VP |
| | Manufacturing; |
| | Initial input by owner not complete by (later) mm/dd/yy - alert |
| | CEO; |
| | Linked successor feedback (e.g., to allow a third pass in |
| | accordance with FIG. 3) not received by mm/dd/yy, alert all |
| | team members |

As can be seen from Table 4, a great number of tasks and subtasks may need to be performed before the Planning Module is complete. Many of these will generate sub-activities which will have their own activity owners, team members, inputs and deliverables.

Returning to FIG. 4, once the Planning Module is complete, the Development Module is entered at step 45a. The development module may include a template that consists of many inputs and deliverables (many or all of which may be generated using activities or sub-activities). Most of the deliverables will again correspond to sub-activities that have their own project owners, deadlines, risks, alerts, etc. As for the Planning Module, the Master Schedule and Budget is maintained and updated as appropriate. Table 5 is a simplified representation of a template for a sub-activity of a Development Module; this sub-activity addresses legal issues.

TABLE 5
Legal Sub-Activity Template Example

| | |
|---|---|
| Activity Name | Legal Sub-Activity; Development Module - Sports Watch |
| Revision Label | B - under review and awaiting input on market position |
| Activity Owner | In-house counsel |
| Team | In-house counsel; VP Marketing; outside patent counsel; outside |
| Members | trademark counsel |
| Inputs | Concept Statement [from Concept Module]; |
| | Detailed design drawings [from Planning Module]; |
| | Marketing Plan [from Planning Module]; |
| | Intellectual Property Plan [from Planning Module]; |
| | Terms for: Pricing and Configuration, Customer Terms and |
| | Conditions [from other activities in the Development Module: ]. |
| Feedback | Information gathered during initialization and presented as fields or |
| information | folders with information from other projects and other sources, such as: |
| | descriptions of the cost and performance of different outside |
| | counsel on patent matter; |
| | notation that, in the last version of this product, there were no |
| | trademarked third party components as there are with this version |
| | and care should be taken to incorporate the third party's guidelines |
| | on trademark notification; |
| | feedback from other product lines suggests that the guidelines for |
| | patent filings outside the United States are often forgotten, and this |
| | has prevented desired protection in key markets. |
| Q&A | Have all trademark and patent filings been completed, in all desired |
| | geographies? |
| | Have all marketing materials (internal and partner) been reviewed |
| | for copyright, trademark, and intellectual property completeness |
| | (both protection and lack of potential infringement)? |
| | Have employee, contractor, and general disclosure agreements been |
| | updated to protect new intellectual property? |
| | Have these new agreements been signed by current employees and |
| | contractors? |
| | Have training and professional services agreements been updated? |
| | Have customer and partner contracts been created and/or updated to |
| | protect new intellectual property? |
| | Are all third party royalty, licensing, and intellectual property |
| | protection measures incorporated within the above documents? |
| Proof Points | Initialed documents of all legal document filings |
| Deliverables | Complete legal product activities checklist, signed by lead counsel; |
| | Summary descriptions of protection being sought. |
| Dependency | Linked Successor Activities (i.e. this activity's output is used by the |
| Lists | following subsequent activities): |
| | Launch Module: Customer Deployment Activity |
| | Launch Module: Partner Deployment Activity |
| | Launch Module: Public Relations Program Activity |
| Criteria for | Completion of this activity to confidence level 9, within xx weeks of |
| success of this | Intellectual Plan activity completed. |
| activity | |
| Pointers to | List of counsel and billing rates; |
| reference | Link to contracts library. |
| materials | |
| Activity | 8/10 - filings complete; risk factors relate to ability to negotiate with |
| Success | vendors. |
| Confidence | |
| Factor | |
| Sign off | Project Manager |
| Alerts | Cost estimate over $yyyy, alert to Project Manager; |
| | Activity not completed 8 weeks prior to earliest planned launch |
| | date, alert product manager, CEO |

Returning to FIG. 4, once the owner of the development module submits the template for completion status at step 45b, the success criteria are measured at step 45c. If the success criteria are not met, the development process continues at step 45a; further modification is required. Otherwise, the module is marked as complete at step 45d.

Upon completion of the Development Module, the Deployment Module is entered at step 46a. As described to respect to FIG. 1, the Deployment Module includes templates and sub-activity templates directed to monitoring the launch of the product, including marketing, advertising, sales, distribution, etc. As completing the Development Module involves implementation of what was performed in the Planning Module, the Deployment Module similarly implements the plans and materials generated in the Development Module.

After the product has been deployed, and the success criteria are complete at step 46c, the module is marked as complete and the project enters a Maintenance Module at step 47a. The Maintenance Module includes activities for both maintaining the product (e.g., completing or fulfilling warranty and service agreement responsibilities) as well as continually monitoring performance and feedback. That performance and feedback is used both to fine tune the procedures that have already been implemented as well as to learn additional information for use in future product designs. As a result of the Maintenance Module, for example, feedback may result in new tasks being assigned to earlier modules or previously completed activities. For example, as a result of consumer feedback, a new feature may be added to the product in the form of a longer warranty or the addition of website support. The result would be to trigger new activities in the Planning, Development, and Deployment Modules in order to implement such changes.

Part of the Maintenance Module activities may include periodic alerts to evaluate when and if the product should be discontinued, based on pre-defined criteria (e.g. a 5 year life cycle could have been entered, with initial notification to customers 1 year prior to obsolescence, and an alert to the project team to evaluate this timeframe and approach 3 years after initial launch.)

Again referring to FIG. 4, step 48a illustrates what happens in this embodiment when data is updated at the completion of a module or sub-activity. (This or similar processing may also occur whenever new data is received and marked as relevant for the particular module or activity.) At step 48a, it is determined whether the data alters the success measures for the module or the status of any completed modules or activities. This determination can be made by automatic calculation and/or manual input by a team member. If a success measure is altered, at step 48e, (i) all of the possible alerts are processed and (ii) the appropriate module/activity owners are alerted that there may be new open issues for that particular aspect of the project. Otherwise, at step 48b, it is determined whether this is the final data required for the closure of all modules for the project. If not, the appropriate successor modules or sub-activities are alerted, again at step 48e. If so, the data is closed, the module is closed and the project is closed and exited, at step 48d.

Linking Tools for Feedback and Other Information.

Access to several types of information may be useful in the project. First, there may be useful information from previous projects about the process itself, including template content, deliverables and all data associated with activity completion, master schedules and budgets, and resources. This may be referred to as “project feedback” information. Second, there may be useful information about this product, or previous similar products, based on feedback from customers. This may be referred to as “customer feedback” information. Third, useful information may be available from external sources or reference materials. This may be referred to as “reference” information.

Making information available to project activities and team members can include three classes or activity: gathering the information, mining the information for what is relevant and making the information available during a project.

For the first, some information is already in a pre-defined form, such as a text file of an analyst's report. Other types of information can be gathered in a fashion to assist in its use in future design projects. For example, a customer survey can be designed specifically to permit its direct incorporation into a feedback database. For example, rating information for each product feature can be requested, such as “rate the color of the watch face from 1-10” or “from 1-10, how important is accuracy? how important is web support?”, etc. In other words, the survey can be designed to assess the relative correlation between the design features and the acceptance by customers.

Project design information may already be included in templates from previous designs. In addition (or instead), team members could be provided a questionnaire (e.g., automatically on closure of a module or sub-activity) asking for those areas of input that are believed to be useful for future projects.

A variety of tools may be used to identify potentially relevant data from within or outside a database. These tools may include search engines to identify keywords (automatically or as specified by a team member), expert-based rules systems or other artificial intelligence techniques.

The relevant information may be used in at least one of two ways. First, the information may be used directly to adjust default templates or in the design of new templates for a project. For example, as a result of feedback from an earlier project, different proof points or different sign-offs might be required for various modules or sub-activities. This use of feedback may be done as part of the initialization of a project and updated as the project progresses.

Second, the information may be used or accessed during the project itself. One potential user interface feature is to include a reference information link editor to assist in linking of feedback reports and other reference information to templates, e.g., where direct access to that material is thought to be potentially helpful to completion of that aspect of the project. (Reports may be accessed in the example of FIG. 9 discussed below by clicking on the feedback icon within the area 96.)

A feedback report would permit a view of all potentially relevant feedback presented to date, and which (if any) feedback has already been linked to a particular feature activity. Doing so permits a team member, each time a point of feedback is received, to identify (using the product status matrix of FIG. 9, for example) which modules and sub-activities might be affected by that feedback.

The team member could then go through and link different types of available feedback to additional identified modules or sub-activities, thereby assuring immediate access to the feedback during performance of tasks in the development process.

As described above, when feedback information is updated or new feedback information arrives, the owners of the affected tasks and activities may be alerted, and then queried to confirm or refute whether this feedback impacts anything that has been done before. If so, a modification is made and all predecessors and successors are notified (potentially requiring modifications for those activities which could in turn trigger modification of other activities). If the new information does not impact the design, the system may still retain a recorded sign-off to show that the feedback was considered for each task for which it might be relevant.

In those embodiments of the present inventions that include a feedback report and editor, further advantages can be attained. Immediate incorporation of customer, internal and external feedback as well as relevant reference materials can be essential to product success but neglected by the individual designer because it is not handy or is difficult for that individual to access. By providing a tool to link old and new feedback (and/or other reference material) to the appropriate activities, one can enhance the likelihood that feedback is incorporated into the design process and that the product development process will react more quickly and efficiently to new information.

A further use of feedback information, and particularly feedback from previous projects, is to use a correlator to draw comparisons between a previous project and the current one. By examining where mistakes (e.g., tracked through logging of alert messages and/or through changes to budget and schedule) occurred in other projects, analogies (using artificial intelligence or otherwise) can be drawn to the progress of a current project. This information can again be used to alter the project (e.g., by altering project templates to have different content such as added approvals, more proof points, new deliverables, etc.) or to provide new/additional alert conditions triggering notice to the project manager or others. The information can also be provided in the form of feedback (as described above) that may be relevant to setting confidence factors for respective activities.

Other Features That May Be Built Into the Templates or Otherwise Incorporated into a Design System or Process.

While one embodiment of an implementation of several aspects of the present inventions has been described above, a number of other inventive features may be incorporated into the design process, in other embodiments of the present inventions.

Automated update. In certain embodiments of the present inventions, the entry of new information can automatically trigger queries to owners of related modules of sub-activities. For example, when vendor information is updated in a general database, all templates (default or customized) which include links to that vendor information could be automatically informed that new data is available. In another embodiment, the owner of the affected sub-activity or module may be required to sign off on whether this new information impacts any of the content (such as identity of a supplier) or other information (such as lowering the cost of goods or increasing a confidence factor).

Another form of notification of updated information may occur when data is modified in a predecessor or successor task. For example, when an answer to a question in a Q & A section is changed, each of the successor and predecessor activities could be notified. Similarly, if the cost or the confidence value of a particular template representing a sub-activity or module is changed, each predecessor and successor activities could be notified of this. On notification, the owner (or other designee) for the notified module or sub-activity could again be required to acknowledge receipt of the update and sign off on whether this updated information requires modification of the information for the particular module or sub-activity.

When this particular aspect of the present inventions is implemented, updated information is automatically proliferated to all of the relevant aspects of the project, so that flexibility to acquisition of new information and speed of reaction to design changes is enhanced.

“Shoot-Outs.” Certain templates in the product development process may include a “shoot-out” as a sub-activity. A “shoot-out” is a particular event that requires that two or more alternatives be proposed, with an analysis performed to assess which is best. By specifically requiring a shoot-out for certain activities, the chance of a more careful analysis of alternatives is enhanced.

For example, the template for a product Planning Module (for those embodiments that use this template) could include as a sub-activity a “product design shoot-out.” In this particular example, the shoot-out could require two (or more) competing and complete product designs. Each design would then be evaluated (as triggered by applicable questions or other sub-activities) to mock (or real) customer analysis. That feedback (as well as the current cost/pricing estimates for each design) could then be used to select the best design. In this particular example, one of the success criteria for completion of the Planning Module could be survival of a “product architecture shoot-out.”

Shoot-outs could be included in other aspects of the design process. For example, selection of vendors could be subjected to a “shoot-out” which is similar to requiring a bidding process among vendors.

Feature release checkpoints. Other modules or sub-activities may call for customer feedback during the design process. As before, this could be built into the templates through Q&A's or by other mechanisms that assure that the task will be performed.

As one example, specific feedback on feature behavior may be important early in the development process. Where this is the case, the Priorities Module may require mock customer or actual customer information about individual features or groups of features. As described above, the feature may be a quality of the product such as color or size or may be a related service such as Internet support.

Instead of completing the entire product development and then introducing the entire product for testing and early customer feedback, it may be advantageous to get feedback on key or complex features much earlier, particularly if such features are hard to describe in design documents, and may be implemented in several alternative ways that may subtlety or not-so-subtlety change the behavior of the feature in the eyes of the customer. For example, if the requirement is for the sports watch to have a blue face, and there was no mention of the shade of blue (an easily overlooked omission in the design specification) when customers see that the blue is identical to common swimming pool wall blues and is thus hard to see the product could be a disaster; early modifications to the design could instead have been performed before inventory has been stocked with undesirably colored watch faces.

Thus, where appropriate, the Priority Module template (or one of its sub-activities) may call for customer feedback and include as a success criteria that the feature set achieve certain quantitative measures in that feedback, or pass consumer testing in some other fashion. (Where automated alerts are used, if the feature set falls below certain quantitative measures, an alert may be sent to the product manager or the VP of Marketing).

As will be appreciated, feature release checkpoints, or other types of checkpoints, may be incorporated into any of the modules of the project or into other sub-activities of the project. Other checkpoints may be used, for example, between each module to alert the team that a particular milestone (here, completion of a module) has been reached. These checkpoints may simply be reminders for all of the team members and perhaps others (e.g., a higher level manager) to use one of more of the user interface features described below to check on the status of the project.

Any number of checkpoints could be used to trigger such a reminder. For example, checkpoints could be created on the completion of a preliminary and/or the first full Master Schedule and Budget described above, the completion of each module (e.g., after the selection of features in the priority section), at the beginning of a product architecture shoot-out, etc.

Vendor Tracker. A vendor tracker component may be incorporated into a system. In one embodiment, a vendor tracker permits coordinated access to one or more of the following: (i) the process of negotiating with and contracting with outside vendors, (ii) tracking the vendors' performance, and (iii) generating feedback for use in future projects. Spreadsheets or other tools may be coordinated and used to track the negotiations (and tracking changes to contracts), changes in statements of work (e.g., for a house, the addition of a few electrical outlets or use of a cheaper front door) and the performance of each part of the vendor's tasks.

User Interface Features.

When certain aspects of the above embodiment are implemented in software, a number of user interface tools may be provided to permit or enhance the ability of team members to assess the status of the project as a whole, or the status of portions or aspects of the project. These tools represent ways for the authorized team members to access the data that is stored within the system as templates or otherwise.

FIG. 9 illustrates one embodiment of a user interface for accessing all of the available information in a product-development process. Of course, other mechanisms could be used to access this data, based on the disclosure provided herein, and the particular layout and arrangement of items is not intended to be limiting.

In FIG. 9, the user is presented with a computer screen 90. Within the computer screen 90 is a global level access diagram 92 that includes an entry for each of the major modules of the particular product development process. In this example, the modules are concept, feasibility, priorities, planning, development, deployment and maintenance. These modules correspond to the major product development segments of activity described above, although other ways of organizing the modules are possible and within the scope of the present inventions.

In the example shown in FIG. 9, a user has clicked on the Concept Module entry in the region 92. As a result, a high level status display for the Concept Module is displayed as shown at 98. In this particular example, the status of the Concept Module is listed as the initial (first pass) input is in progress. Five of a total of eight activities have been completed (which may correspond to the complete answering of five of eight questions in the Q&A section, in those embodiments where a Q&A section is used to input data).

Other status level information shown at 98 includes the current average activity confidence level, which represents the average of confidence that each of the activities within the Concept Module will be completed successfully. Also included in the high level status display 98 are the target completion date and any medium or high level alerts (color coded or otherwise) that have been issued and not resolved for the Concept Module.

Within the Concept Module highlights area 93, is a region 97 where a user can activate an icon to drill down for more information pertaining to the Concept Module. In this example, an icon with an exclamation point permits a user to access any medium or high level alerts that have been issued for the Concept Module or any sub-activity of the Concept Module. An icon with a label of D permits a user to drill down into a series of displays that show the user the details for any sub-activities for the Concept Module. An icon with a time clock permits a user to drill down into the Master Schedule. Finally, an icon with arrows permits the user to access predecessor and successor dependencies for this particular module as well as feedback and reference materials. Of course, a user could derive any number of different possibilities for disclosing the status of concepts, based on the disclosure provided herein.

Each of the other modules illustrated in the region 92 may be clicked on and a similar (in this embodiment) high level status report is reported for each module. In addition, the sub-activities predecessor and successor links may also be accessed for each of those modules.

Although it might appear that additional information on the other modules would be unavailable at the status screen at the design very beginning of the process, in certain embodiments this may not be the case. For example, if a complete set of default templates for an entire project is incorporated as a part of the initialization phase in the embodiment described above, then a complete set of templates is available at the beginning of the project (albeit with some or much of the information being blank), and can be tailored for the project using (in this example) an interface tool, such as the one shown in FIG. 9, to access the templates.

Returning to the screen display 90, product status information may be included in a box 91. Here, the name of the project (which in this case is the same as the name of the product) is displayed. Optionally, the project name may also include the revision level. In addition, the current module of the project (e.g., the most recently entered module of FIG. 4) is displayed. A target date or window for launch of the product is shown. In addition, the next major milestone for the product development process is listed. (Major milestones may be identified within the default templates or during the product development process, using a label within the applicable module and sub-activity templates.) The confidence level for the next major milestone as well as the current confidence level estimate for a deployment of the product may also be shown. The product owner (e.g., the project manager) is also listed. Finally, all major alerts are listed, including alerts for all modules and sub-activities for the project. As one might appreciate, each of these entries could be linked to new windows with further information.

Screen 90 may also include a legend 95 that identifies the function of icons. This legend may be static or may be dynamically updated depending on the particular module being shown. Of course, other icons and buttons could be included in the user interface and would be readily apparent to one of ordinary skill in the art based on the disclosure provided herein.

In the screen 90, access to the data management and reference library is also provided at 94. In this particular example, icons 96 permit access to various classes of information stored in the reference library. Any number of classes of information may be accessed in this manner, as would be apparent to one of ordinary skill in the art based on the disclosure provided herein. In this particular example, access is provided to all reports (e.g., marketing analysis, video-tapes of product “shoot-outs”, concept statement, customer feedback reports, and other studies), product documents (e.g., any design documents, feature lists and contracts), the Master Schedule and Budget, feedback data, and team data, including information pertaining to each of the team members, their tasks and responsibilities. All of this information may be stored in a commercially available or custom database and queried in response to activation of an icon 96 or accessed through key word searches, Boolean logic, etc.

Other user interface features which may be accessed either through the product status matrix display of FIG. 9 or otherwise include the following.

Confidence meter. A confidence meter may be used to graphically show the confidence factors through all modules of the development process. This may include a hierarchy of confidence meters showing the entire (or portions of the) project. Thus, a confidence meter could show either an assigned, or a computed aggregate, confidence factor for the project as a whole. For each module that has been completed, a confidence factor could be shown then for each sub-activity within each module and a separate meter could be shown for the module as a whole. The confidence meter may be displaced graphically, such as with a partially filled 2d or 3d bar, chart, or numerically.

Where a confidence meter is implemented, a project manager or other team member may identify readily which activity confidence factors are impacting the likelihood of a successful launch for the product most heavily, and therefore, provide a snapshot of what activities impose the greatest risks to a successful launch of the product. This may permit the product manager to quickly assess the needs of the project and determine where to devote additional resources for maximum effect.

Success meter. Success meters may also be used to show the quality of the results of individual tasks or segments of the project. In embodiments where this is done, the rating for the particular activities could be attributed to the activity and to the owner of that activity. This can be used to evaluate the performance of the members of the team both to permit feedback for future products and to otherwise assist in employee evaluation.

Success criteria can include quality, but it is flexible to be defined however the project dictates. Thus, there may be a linkage between individual task success and overall success, because the methodology and system allow the templates to be created that way. For example, if time to market is more important than product quality, this success measure would trickle down and be reflected in the content of the templates. The user interface could quickly show how successful activities have been, measured to their criteria and scored—e.g., met success criteria within 10% of schedule. Exceeded success criteria by over 10% etc. could provide quantitative scores. Where this is done, correlation statistic reports may show, for example, how often the overall product success was achieved when certain conditions are met, such as when:

More than 50% of the activities had success criteria met within 10% of the target date

The initial confidence factor during the design phase was less than 3

By incorporating success measures for particular modules and activities, each particular task or activity may be separately graded, helping to assure that attention is given to the success criteria (including product quality) at every module. In some embodiments, the measure can reflect the relative importance of the particular activity or feature affected. Thus product quality becomes simply another success factor, and may be weighted, neglected, or emphasized based on the particular needs of a project or specific project activity. For example, quality may be very important for the crystal of a watch (difficult and annoying to replace), but less important for the battery, since it is easily replaced. Use of a standard battery may, however, be important.

Resource and budget monitor. A further user interface tool that can be employed in certain embodiments of the present inventions is a resource and budget monitor. Similar to the confidence factor assessment interface described above, this tool permits a graphic (or other) display of the resources and budget for the entire process with a hierarchical breakdown of the resources consumed for each particular module and for each particular sub-activity. The resources for the product development process as a whole is an aggregation of the resources consumed by each of the modules and sub-activities; actual data may also be compared against targets using this tool. In certain embodiments, particularly where a similar project has been completed, resource and budget comparisons with reference data can be made graphically or in tabular form. Once again, by presenting a complete graphical representation of all the resources being consumed, a project manager or other team member can readily ascertain whether a disproportionate amount of the resources are being invested in a particular aspect of the project.

Just as with activities, resource and budget alerts can be established during the initialization part of the project (and imported from previous projects) and/or supplemented throughout the course of the project, to alert users when a resource re-alignment may be required. In other embodiments, resources themselves can “call for help” within the system when they fall behind a pre-set % completion target and/or expend more than anticipated time or money on an activity or deliverable.

Other user interface features and mechanisms would be readily apparent to one with ordinary skill in the art based on the disclosure provided herein and other tools may be incorporated into this system, such as tools to support video instruction, web-based meetings, etc.

Project risk management tool. According to certain embodiments of the present inventions, a project can be effectively managed by more carefully tracking those areas where there is risk. Thus, for example, a project may be managed in the following way.

First, the project is broken down into a number of pieces, to permit a more careful estimation of resources and risk for that aspect of the design.

Second, a target architecture or design is derived, intended to incorporate the various aspects of the project, while leaving room for flexibility and the addition of new features.

Third, an assessment of all of the pieces of the project is made, so that the project manager and others can ascertain where the risk is and where the cost is.

The fourth is a detailed design, emphasizing up-front those areas that are determined to have greater risk.

Following this process permits identification of major stumbling blocks earlier in the process, when it is easier to adjust to problems (or cancel the project, if appropriate) and permits the project manager and others to determine where to devote their time and where to allocate the best resources (e.g., the best designers).

Where this process is followed, and even where it is not, project management tools may be provided to help assess risk, cost and delay using the tools described in this specification. As described above, certain embodiments of the present inventions permit a project manager to examine the project at a number of levels of detail-module, activity or sub-activity. Indeed, tools may be provided to permit a project manager to view the entire “tree” of dependencies in the project and to expand or collapse nodes in the tree. In this view (or otherwise), a measure of risk measurement (based, for example, on the confidence factor), resource measurement (e.g., cost or time and disbursement), and/or time for completion, can be associated with each sub-activity or group of activities.

Since each piece of information is kept up to date, a project manager can take a snapshot of the project at any point in time and devote time/attention accordingly. Doing so can increase the chance of success for the project, reduce delays and be less expensive by making sure attention is provided to risky pieces up-front and by permitting the project manager or others to spend less time worrying about aspects of the project that are less risky and/or less costly.

Activity content building tool. Another mechanism that could be implemented in certain embodiments of the present inventions is a format for building content in a particular module or sub activity template, such as in the Q and A portion of a template described above (where a Q and A portion is used).

FIG. 10 illustrates one example of an activity content builder screen. In this particular example, the activity represented is one to develop installation procedures and documentation for a software product.

The screen 100 includes an area region 101 where the particular module, activity and sub-activity are identified. In this particular example, the module may be a development module, the activity may be documentation and the sub-activity may be installation procedures and documentation.

Also in region 101 are icons that permit access to information about the predecessors and successors for this particular activity. This permits a user to immediately view what impacts or is impacted by activity being performed in this particular sub-activity.

Region 102 includes summary status information for this particular activity. In this example, there are labels for owners, alerts, target dates, current and targeted confidence levels, as well as summary listings of predecessor and successor activities. Icons in the region 102 also allow a user to drill down to other information. In this example, particular icons allow drilling down to additional detail about the activity as a whole and an icon leading directly to the criteria for successful completion of this activity.

In this particular example, the screen 100 is being used for completion of one of the questions in the activity content builder for the installation procedures and documentation sub-activity. The applicable question and a template for completing the answer are illustrated in region 103 of screen 100. Here, the question is “what are the steps for installing this product?” A determination of those steps, plainly, is an important aspect of what the installation procedure ought to be.

The answer region of area 103 permits a user to input an answer in the format of a previously formatted template table of steps s1 . . . sn. Alternatively, other mechanisms could be used for inputting the procedure steps, including entry into a spreadsheet, entry into a word document etc.

In this particular example, dependency information from the answer may be included in region 104. Here, two particular areas of dependency are shown. One is a customer pre-installation checklist which is a word processing document that the customer would be required to review and sign prior to the software being shipped to the customer. That document may be automatically generated based on the answers input in region 103 or instead may be a link to a document that the user would input. A combination of the two may also be employed, with parts pre-populated and parts completed by the user.

Also in region 104 is a related document for a particular calculation that must performed as part of the installation process. That calculation is stored, in this example, in a spreadsheet. Once again, that spreadsheet could be generated or populated as part of a template where a similar product has been designed. Alternatively it could be input here for the first time by the user and archived for potential use in later projects.

Region 105 of screen 100 includes proof point data. This may advantageously be included at each level of the content builder to remind the designer that they need to prove up successful completion of the task as a part of the performance of that module or sub-activity.

In this particular example, the proof point could have been pre-established to be the use of the developed installation procedure in an actual installation and a report indicating success. In the example of FIG. 10, the result of the proof point is a proof point report (document) that identifies a missing step. Here, the missing step is that disk storage verification must be included as part of the pre-installation process.

Region 106 of screen 100 illustrates pop-up links to available feedback information. As described above, feedback information may come from comments made to previous versions in this project or another project. Feedback may also come from customer feedback for this project or other projects.

By automatically showing in particular content builders that feedback information is available, the likelihood that the feedback is actually employed in the development process is increased—resulting in a more efficient and perhaps better design process.

As described above, a feedback editor may be used as part of the project status interface, allowing automatic population of affected templates each time that new feedback information is identified as relevant to this particular product development project. The algorithms that identify this feedback as relevant to a particular resource, activity, sub-activity, deliverable, project, etc. can be simple as described or more complex (rules-based expert systems, fuzzy logic, neural networks, etc.).

Area 107 of screen 100 includes icons that allow linking to relevant referenced library materials. For example, these icons might link to design details, earlier documents for installation of other products, support information for software vendors, etc.

Region 108 includes other buttons related to the activity content builder. In this particular example, a single question and answer is displayed as a part of the screen 100. Two of the buttons in region 108 permit the user to scroll back and forth along the questions. In addition, an icon is illustrated to permit access to a help feature.

Finally, in screen 100 there is a submit button 109. Activating the submit button in this particular embodiment would cause the system to store the answers recorded in this particular activity content builder and update any applicable information, and submit for completion status, which would invoke checking whether this activity's deliverables satisfied the success criteria.

Software Architecture

When implemented in software, any appropriate mechanism may be used to implement one or more aspects of the present inventions. In one embodiment, a windows operating system can be used to build the user interface for completion of various project modules. The program may (but need not) be written in an object oriented programming language with the individual templates or modules and activities being programmed as their own object.

Preferably, the software is implemented in a manner that permits multiple project team members and external parties to access information in the system, who may have different levels of access authorization to read data, write data and change initialization parameters, etc. The software can be written in components or as a complete system.

In a complete system, support may be provided to allow multiple forms of access, such are permitting use of an internet web browser, mobile personal digital personal assistance or wireless telephone to access one or many features of the program.

While not intended to be limiting with respect to concepts described above, one particularly advantageous software architecture may use different layers of processing.

In one embodiment of this software architecture, four different layers of independent but linked processing are used. These are:

The user interface and the administration interface layer, which includes input and output functions, reports and status views and handles alerts as pop up windows, electronic mail, automated facsimile messages or other mechanism. The user interface and the administration layers may also include functionality for interactive programs such as questions and answer wizards. This layer may also employ pull down menus, flashing status bars, forward backward and finished component sequences and other user interface mechanisms to facilitate the input of information and the display of information for analysis.

A methodology and activities layer, which contains programs and wizards that perform the product management process, for example using templates as described above. Each of the modules and sub-activities may have associated software for managing its application. These programs further determine what activities remain to be performed, are incomplete or have been completed, and calculate the information such as aggregate success probabilities, confidence factors, risks, budget information, etc., for presentation to the user during user interface in administration layer.

A linkage and adaptive feedback layer, which contains rules and dependencies among the activities and templates and modules, and maps feedback (as appropriate in particular embodiments using a feedback editor provided in the user interface) to assure that information is delivered to the right activity and templates. Risk management security and authorization may also be performed at the linkage and adaptive feedback layer. This particular layer may handle communication among the various activities to assure that information is updated to the appropriate places.

A data management, reference library and external interface layer. This layer would include the database for programs, templates and wizards that make up an automated project management system. The data may include (among other things) the Master Schedule, activities information, predefined templates, Q and A wizard steps, feedback data, archival information from previous projects and versions of this project, system parameters such as alert thresholds, user profiles, authorization profiles, etc. The database may either incorporate or include pointers to include external information and databases, such as links to vendors' websites. The data management and reference library layer may further include authorization access information to ensure that team members only receive the appropriate level of access. For example, it may not be appropriate for a programmer to be able to retrieve all of the information in a resource library that concerns other employees.

One advantage of isolating the different layers of the software architecture is to permit modification in discrete areas. For example, isolation of the methodology layer permits adaptation of those mechanisms to particular requirements of individual organizations, such as local government regulatory requirements or product life cycle process requirements for a particular organization.

The software may include typical interfaces for other programs such as electronic mail, word processing programs, spreadsheet programs, permitting playing of video taped archived information (e.g. of a customer interview as part of the feedback link), etc.

The data reference layer may include templates from other projects that may be used in future projects. In addition, there may be default templates that can be employed by any business. For example, there could be different sets of default templates for business to business technology products (software and hardware may require separate sets), professional services, application service providers, business to business complex technology systems, enterprise customer relationship management projects, call center reengineering or general enterprise information technology projects. As described above, there could also be different default templates for small consumer products, large consumer products, etc.

The software may further include a project development template editor, which permits users to customize existing default templates or create an entire set of templates on their own. Such interfaces could also be deployed to carry out activities in a “stand alone environments” as well as in conjunction with a complete system. Interfaces may also be customized for developing templates to be used in specific environments and could for example include features for developing templates for data and procedural integration with enterprise software used for manufacturing and inventory, human resource planning, customer relationship management, marketing and sales, accounting and financial management, etc.

Further aspects of the present inventions may be understood with reference to tracking of the completion of an activity within a project and with reference to the four software architectural levels described above. While this example is intended to be illustrative of various concepts embodying the present inventions, the particular details are not intended to be limiting, and different aspects of this embodiment and the other embodiments in this application may be employed independently of the four software architecture levels.

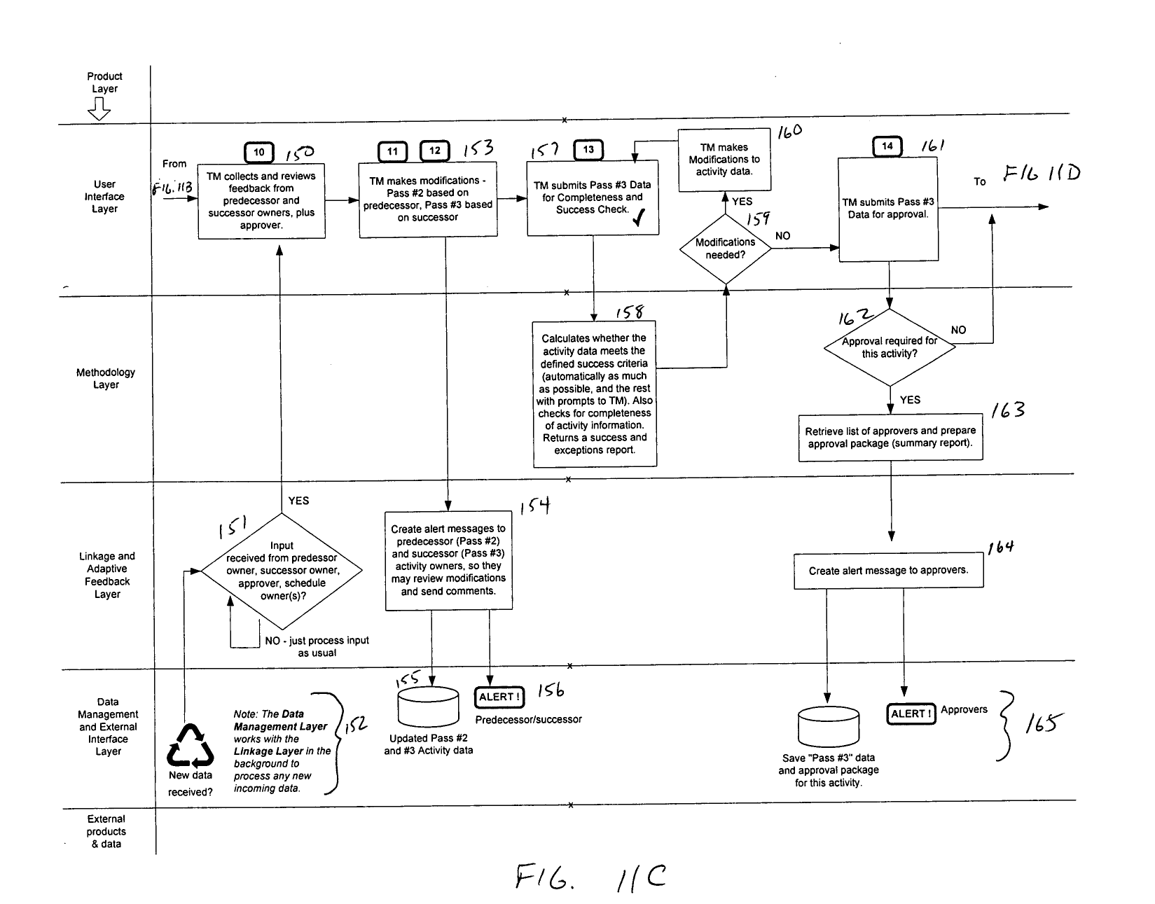

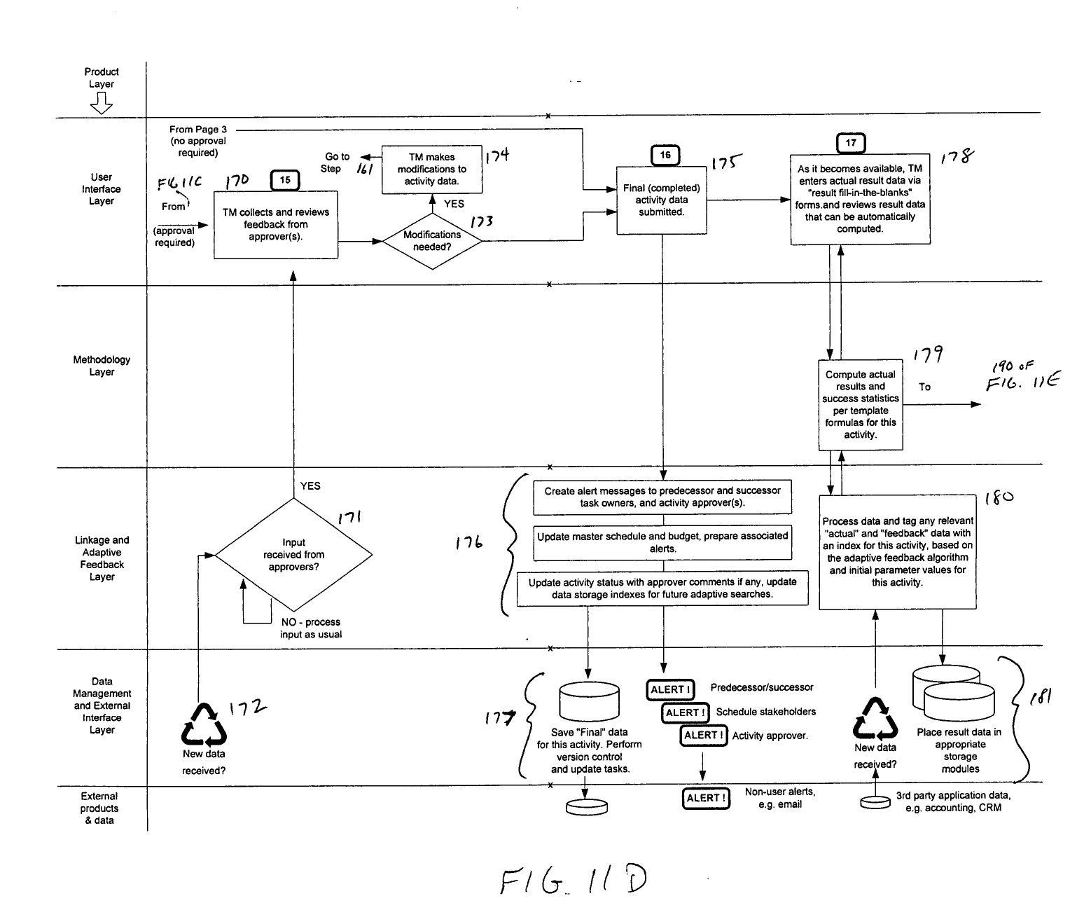

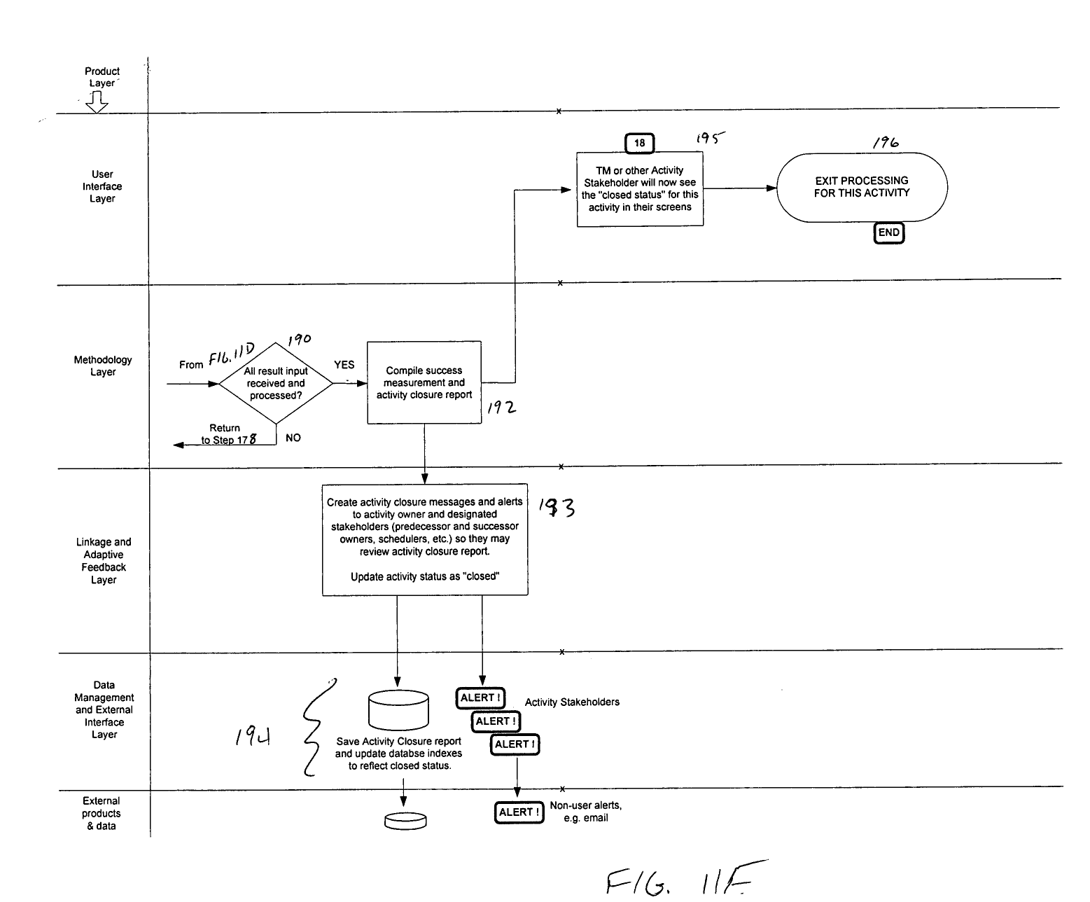

FIGS. 11A-E illustrate one example of application of one embodiment of certain aspects of the present inventions using the four layer software architecture described above.

In FIG. 11A, the various layers of the software architecture are illustrated in Column 1000. The user interface layer is row 1001. The methodology layer is row 1002. The linkage and adaptive feedback layer is row 1003, and the data management and external interface layer is row 1004. Also illustrated is a row 1005, indicating external products and data layer that may be accessed by the system.

Processing in this example begins at step 110, when a team member opens an activity or sub-activity.

Once this input is made at the user interface layer, template information for the particular sub-activity is retrieved at step 111. This may include accessing wizard Q&A's, success criteria, and all of the other information and attachments that may be indicated in the applicable template.

After the methodology layer 1002 retrieves a particular template at step 111, the linkage and adaptive feedback layer 1003 can update or retrieve applicable reference data, by building a search (assuming that the data is stored on the database in the data management and external reference layer).

In certain embodiments, at step 113, a feedback algorithm may be performed to correlate the latest results, to learn what was successful and what was not successful. This information may be used in future iterations of this product and in the design process of other process. By insuring that this data is entered as the project progresses, an organization can optimize its ability to improve through experience.

In the data management and external interface layer 1004, data is retrieved for the foregoing steps. Thus, data may be saved, predecessor and successor activity data may be updated (for example, updating of feedback can cause that information to ripple through this project and other projects as described above). Attachments for this activity are retrieved, templates are retrieved, schedule resource budget data may be updated, alerts are processed, feedback and actual results are entered, and applicable information is stored and archived.

The next activity immediately apparent to the user occurs at step 115. Here, the applicable information for completion of the activity is displayed. For example, an activity content screen, such as that illustrated in FIG. 10, may be displayed to the user.

At step 116, the team member then completes basic activity information, for example, by answering Q&A wizard questions and filling in the blanks.

At step 117, the team member enters proof point data. Once this is completed, the team member may submit the Q&A and proof point entries.

At step 119 it is determined whether any attachments need to be auto-populated, based on answers in the Q&A. One of the questions may, for example, require a user to select several options for a legal contract; after the options are selected, a form may be generated automatically (or auto-populated) based on that input. Where this is the case, at step 120, the applicable attachment is generated and provided at 121 for access by the user.

After this is done, or if auto-population is not required, the team member is given the opportunity to review all of the attachments and assure themselves that they are satisfied with the results of this pass at the activity, at step 122.

Referring to FIG. 11B, processing continues at step 130, where the team member enters any relevant schedule resource, budget/cost, and risk information. The team member then enters an activity confidence factor. Entry of all this information may be done with applicable user interface mechanisms as described above, or as would otherwise be apparent to one of ordinary skill in the art based on the disclosure provided herein.

At step 131, it is determined (in the methodology layer 1002) whether the updated data alters the Master Schedule and Budget beyond certain alert thresholds. In order to make this assessment, an external interface may be accessed at 132 to check the appropriate information.

At step 133, the impact of any alterations is determined. Where appropriate, alert conditions (e.g., color-coded alarms or alerts that have been assigned different priority levels) may be issued for the individual as identified in the templates.

At step 134, the impact of any alterations is displayed to the team member, and the team member is prompted for final modifications.

Where there is no impact or the team member is satisfied that they wish to submit this pass for assessment, processing continues as step 135. At step 135, the team member submits the first pass data for a completeness and criteria assessment.

This is submitted again to the methodology layer 1002, which calculates whether the activity data meets the defined success criteria. This may, for example, involve success criteria assessment as described above or could be done manually by either the team member or a supervisor of the team member. A success and exceptions report may be issued as a result of evaluation of completion of this activity.

If it is determined that modifications are required (for example, if the success criteria have failed or the information is not complete) at step 137, at step 138 the team member is notified and given the opportunity to modify the content data for the activity. The team member may be provided detail as to why the criteria were not met and may further be provided with advice and past examples as to how to meet the criteria. If this pass has met the success criteria, processing continues at step 131 where the team member submits the data for distribution in an interim saving/archiving of this pass at the activity. When this is done, the linkage and adaptive feedback layer 1003 then feeds the information to all of the different modules and sub-activities (e.g., through their templates) at step 140. Thus, at step 140, alert messages may be generated and sent to predecessor and successor task owners so that they are immediately notified that this module or sub-activity has been completed. This may impact the ongoing activities for each or may trigger them to initiate subsequent activities.

At step 141, alerts to priorities and Master Schedule Risk and Budget views are updated. Once again, the completion of a particular activity could cause alterations in the total budget or the Master Schedule. Notification alerts a product manager to view each of these and permits immediate response to any possible deviation in the product development process.

At step 142, activity status, data storage indices and other information for future products are updated.

As indicated at 143, the data management and external interface layer may process this information and send applicable alerts to owners of predecessor/successor activities, schedule stakeholders, individuals identified required to sign off or approve completion of this activity, and any non-users alerted by email or facsimile.

As indicated at FIG. 144 of 11B, information that has been processed is also saved and archived in the database for the system.

Returning to step 139, after the team member has submitted the first pass data for an interim save, processing continues in FIG. 11C at step 150.

At step 150, the team member collects and reviews feedback from predecessors and successor owners in the approver period. This may occur as a result of having submitted the first pass at all the success criteria. Alternatively, it may be the result of new feedback becoming available and automatically triggering activation of this activity again. It may also be the result of new feedback from the predecessor activity triggering a second pass (as in FIG. 3 described above) or may occur after successor information is available triggering a third pass at this activity.

Thus, as indicated at step 151, input from a predecessor, successor, approver, or other from the linkage and adaptive feedback layer may cause step 150 to be triggered. As indicated in 152, this may be initiated with the receipt of new data at the data management and external interface layer.

At step 153, the team member makes modifications for a second pass if the result of predecessor feedback, or a third pass if the result of successor feedback.

As before, at step 154, alert messages are generated as the result of particular modifications to the information in this activity template. As indicated at 155 and 156, applicable alerts are generated in information stored in the database for this project.

Returning to 153, after the team member makes modifications, the team member submits (step 157) the new data for a completeness and success criteria check. At step 158, the methodology layer 1002 determines whether the activity data continues to meet the success criteria (alternatively different success criteria may be applied for different passes; for example, the criteria for success in the last pass of a particular activity may be more stringent than the criteria for success in a first pass).

As before, at steps 159 and 160, it is determined whether modifications are needed and, if so, the team member is given the opportunity to modify that data.

If modifications are not required, at step 161, the team member submits this new pass (here, indicated as pass #3) for approval. As before, at step 162, it is determined whether approval is required. As noted above, this information may be stored as part of the template for this particular activity. If approval is not required, processing continues as described below with reference to FIG. 11 D. If approval is required, at step 163, the list of approvers is retrieved and an approval package (e.g., summary report) may be provided to the reviews. Alternatively, the reviewers may access this information through the product development project user interface as described above.

The linkage and adaptive feedback layer 1003 alerts the applicable approvers at step 164. The alerts are issued and the data archived as indicated at step 165.

After approval, processing continues at step 170 of FIG. 11D.

At step 170, the team member has collected and reviewed any applicable feedback from approvers or as the result of the receipt of new data in 172 triggering additional activity on the part of the team member, as indicated at step 171.

It is determined at step 173 whether this new information may require modifications to the content of the activity. As indicated at step 174, if this is the case the team member is given the opportunity to modify the data and processing continues at step 161 of FIG. 11C. These modifications may require that the approval process be resumed for this activity.

If modifications are not required, the data of this activity has been completed, as indicated at step 175. This triggers, as indicated at 176, the linkage and adaptive feedback layer 1003 to create the appropriate alert messages to identify predecessor and successor task owners as well as activity approvers that this activity has been finalized. The Master Schedule is updated to indicate the completion date as well as any alterations to the budget. Alerts associated with these changes may also be generated based on the applicable templates for these activities. Finally, the activity status and comments are updated, including logging of any associated feedback information.

As indicated at 177, the appropriate alerts are issued by the data management and external interface layer and the data is archived for this activity. Step 178 indicates that, as feedback data continues to be available, the team members may enter the result data and answer question and answer segments on the results of the completion of this activity. At step 179, the methodology layer 1002 may compute results and success statistics per applicable formulas for this activity. Where formulas are unavailable, a user (e.g., the supervisor or a team member) may assign a weight or score for the success of one or more aspects of this activity.

Once this is done, at step 180, process data and feedback data are indexed and stored as indicated at 181. This continuing adaptive feedback may continue and become part of the way that experience is logged and stored for use in future projects and/or for tailoring template structure or content. In addition, new feedback may trigger additional review for potential modification of the results of this activity, as indicated at 171 and 172 of FIG. 11D.

Referring to FIG. 11E, if there is additional input that may become available, processing continues at FIG. 11D and the team member is notified when there is new result data for assessment and analysis. For example, feedback from customers on a product user guide would be desirable to the development module well after development and deployment had been completed. During initialization, a time period and filters for certain data types would be established. Once this time and/or specific type of data collection have been completed, the success measurement and activity closure reports are generated at step 192.

Here, the linkage and adaptive feedback layer 1003 may create the applicable documentation and alerts. The appropriate alerts are issued by the external interface layer and the data management layer saves and archives the relevant data.

In addition, the user interface will display a closed status for this activity and future screens and processing for the activity is completed at step 196 (unless, new feedback creates an alert which causes the team member to be notified and decide to reopen this activity).

The various methods above may be implemented as software on a floppy disk, compact disk, or other storage device, for use in programming or controlling a computer. The computer may be a general purpose computer such as a work station, main frame or personal computer, which performs the steps of the disclosed processes or implements equivalents to the disclosed block diagrams. The software may be included on a diskette as a complete system or as enhancements to an existing system, permitting the system to perform the methods described herein. Alternatively, the system could be installed and maintained separately and sold or licensed to third parties. Portions of the system may also be sold or licensed separately, such as selling default templates in separate releases or providing access to databases to third parties using one or more aspect of the above deign methodology.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

What is claimed is:

1. A method of managing a project, comprising steps of:
providing a set of templates, each of the templates corresponding to respective tasks of the project to be performed;
performing steps of the project in accordance with the templates; and
recording information specified in the templates, during the project.

2. The method of claim 1, wherein the step of providing a set of templates comprises a step of:
selecting a set of templates from among a plurality of sets of default templates.

3. The method of claim 1, wherein substantially all of the project is performed using the templates.

4. The method of claim 1, wherein the project includes a step of planning development of a good to be sold commercially.

5. The method of claim 1, wherein the project includes a step of implementing an information technology project within an organization.

6. The method of claim 1, wherein
the performing step includes a step of designing a product; and
one or more of the templates is populated with design information, in advance of performing the designing step.

7. The method of claim 1, wherein the step of providing a set of templates comprises a step of providing templates pre-populated with information for use in the project.

8. The method of claim 1, wherein one or more of the templates includes information specifying a confidence factor for a respective activity for the template.

9. The method of claim 1, wherein the step of recording comprises a step of storing the information in a field of the template.

10. A method of implementing a project, comprising steps of:
generating a set of electronic templates, each template corresponding to a respective task for the project;
retrieving respective templates in conjunction with performance of the respective tasks;
using the templates to manage the project.

11. The method of claim 10, wherein the generating step comprises steps of:
providing default templates; and
modifying the default templates to customize them for the project.

12. The method of claim 11, wherein the step of modifying comprises steps of:
retrieving information from previously completed projects;
using the retrieved information to determine modifications to the default templates.

13. The method of claim 12, wherein the step of modifying further comprises a step of:
automatically modifying default templates based on performance in past projects.

14. The method of claim 10, wherein the generating step comprises a step of:
providing question-and-answer prompts to assist in completing one or more tasks.

15. The method of claim 10, wherein the using step comprises a step of:
automatically suggesting content for one or more deliverables identified in at least one of the templates.

16. The method of claim 10, wherein the generating step comprises a step of:
assigning a confidence factor to each of a plurality of the tasks.

17. The method of claim 16, wherein the using step comprises a step of:
modifying one of the confidence factors during performance of its respective task.

18. The method of claim 16, further comprising a step of:
determining an aggregated confidence factor, based on confidence factors of a plurality of the tasks.

19. The method of claim 16, wherein the using step comprises steps of:
retrieving information for a group of the tasks; and
identifying areas of risk for the project, based on the retrieved information.

20. The method of claim 10, wherein the generating step comprises a step of:
identifying proof points for a plurality of the tasks.

21. The method of claim 10, wherein the generating step comprises a step of:
assigning dependency links among the tasks.

22. The method of claim 21, wherein the using step comprises a step of:
automatically updating templates based on changes to information in tasks that are identified in the dependency links.

23. The method of claim 22, wherein the dependency link identifies a successor task.

24. The method of claim 22, wherein the dependency link identifies a predecessor task.

25. The method of claim 10, wherein the generating step comprises a step of:
identifying success factors for each of a plurality of the tasks.

26. The method of claim 25, further comprising a step of evaluating the success factors for each of a plurality of the tasks.

27. The method of claim 25, further comprising a step of automatically evaluating a success factor for a task, in response to submission of a template corresponding to the task.

28. The method of claim 10, wherein the using step comprises a step of:
electronically recording feedback information for future projects.

29. The method of claim 10, wherein the generating step comprises a step of:
linking feedback information to one or more of the templates.

30. The method of claim 10, wherein the generating step comprises a step of:
linking respective reference material to each of a plurality of the templates.

31. The method of claim 10, wherein the generating step comprises a step of:
assigning a respective automated alert criterion to each of a plurality of the tasks.

32. The method of claim 10, wherein each of the templates has the same format.

33. A system for managing a project, the system comprising:
means for electronically generating templates, each of the generated templates corresponding to one or more project tasks and including information about performance of the respective task or tasks;
means for specifying dependencies among the templates; and
means for updating the templates during the project.
